(19) United States
(12) Patent Application Publication
(10) Pub. No.: US 2013/0170018 A1
(43) Pub. Date: Jul. 4, 2013

(54) SWITCHABLE OPTICAL ELEMENTS

(71) Applicant: TRITON SYSTEMS, INC., Chelmsford, MA (US)

(72) Inventor: Lawrence H. Domash, Conway, MA (US)

(73) Assignee: TRITON SYSTEMS, INC., Chelmsford, MA (US)

(21) Appl. No.: 13/734,920

(22) Filed: Jan. 4, 2013

Related U.S. Application Data
(60) Provisional application No. 61/583,125, filed on Jan. 4, 2012.

(51) Int. Cl. G02F 1/29

(52) U.S. Cl. CPC G02F 1/29
USPC 359/320

(57) ABSTRACT

Optical filters capable of operating in the infra-red spectrum are disclosed. In one embodiment, a filter may be dynamically switched to provide one of two optical responses. One optical response may include the filter reflecting infra-red radiation across a range of wavelengths except at one or more wavelengths at which the filter absorbs the radiation. A second optical response may include the filter reflecting infra-red radiation across the entire range of wavelengths. In one embodiment, the switching may be caused by the physical displacement of a first filter component with respect to a second filter component. A method of switching the response of such a filter is also disclosed. Another embodiment of the filter may include one in which the optical response of the filter is effectively independent of either the incidence angle of the radiation impinging on it, or the polarization of the incident radiation.

### CROSS-REFERENCE TO RELATED APPLICATIONS

This application claims priority to U.S. provisional patent application Ser. No. 61/583,125 filed Jan. 4, 2012 and entitled “Tunable Optical Elements”, the disclosure of which is incorporated by reference in its entirety.

### GOVERNMENT INTERESTS

This research was conducted with support from the U.S. government under a grant from the U.S. Air Force Research Laboratory (contract number FA8650-12-C-5114). The U.S. government may have certain rights in the invention.

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

Not applicable

### SUMMARY

In an embodiment, a switchable optical element having an optical response to incident radiation may be composed of a ground plane, a patterned nanostructure of metallic features disposed on a dielectric spacer layer electromagnetically coupled to the ground plane, a third component configured to be electromagnetically coupled to the patterned nanostructure, and one or more micromechanical actuators operably connecting the patterned nanostructure and the third component, the one or more micromechanical actuators being capable of providing vertical actuation of the third component relative to the patterned nanostructure. The switchable optical element may optically respond in a first manner to the incident radiation when the third component is at a first vertical displacement from the patterned nanostructure, and optically respond in a second manner to the incident radiation when the third component is at a second vertical displacement from the patterned nanostructure.

In an embodiment, an optical element having an optical response to incident radiation may be composed of a ground plane, and a patterned nanostructure of metallic features disposed on a dielectric spacer layer electromagnetically coupled to the ground plane. The metallic features, each having a geometric shape, may be patterned to produce a two-dimensional array of metallic features, in which the two-dimensional array of metallic features may have an x-dimension spatial period, a y-dimension spatial period, and the x-dimension spatial period may differ from the y-dimension spatial period.

In an embodiment, an optical element having an optical response to incident radiation may be composed of a ground plane, and a patterned nanostructure of metallic features disposed on a dielectric spacer layer electromagnetically coupled to the ground plane. The metallic features, each having a geometric shape, may be patterned to produce a two-dimensional array of metallic features, and the geometric shape may have an x-dimension diameter, a y-dimension diameter, and the x-dimension diameter may differ from the y-dimension diameter.

In an embodiment, a method for switching the optical response of an optical element to incident radiation may include providing an optical element composed of a ground plane, a patterned nanostructure of metallic features disposed on a dielectric spacer layer electromagnetically coupled to the ground plane, and a third component configured to be electromagnetically coupled to the patterned nanostructure, and moving the patterned nanostructure a vertical distance relative to the third component. The optical element may optically respond in a first manner to the incident radiation when the third component is at a first vertical displacement from the patterned nanostructure, and optically respond in a second manner to the incident radiation when the third component is at a second vertical displacement from the patterned nanostructure.

### DESCRIPTION OF DRAWINGS

FIGS. 1A and B illustrate embodiments of a patterned nanostructure in accordance with the present disclosure.

FIG. 2 illustrates an embodiment of electric fields generated by exposing a nanostructure feature to optical radiation in accordance with the present disclosure.

FIG. 3 illustrates an embodiment of a metamaterial including a patterned nanostructure in accordance with the present disclosure.

FIG. 4 illustrates a number of simulated absorbance spectra of an embodiment of a metamaterial illustrated in FIG. 3 in accordance with the present disclosure.

FIGS. 5A-C illustrate embodiments of two-dimensional arrays of nanostructure metallic features in accordance with the present disclosure.

FIG. 6 illustrates an embodiment of an optical element having an upper medium disposed over a nanostructure in accordance with the present disclosure.

FIG. 7 illustrates simulated transmission spectra of an embodiment of an optical element having an upper medium disposed over a nanostructure as illustrated in FIG. 6 in accordance with the present disclosure.

FIG. 8 illustrates an embodiment of an optical element having a laterally movable upper medium having multiple projections disposed over a nanostructure in accordance with the present disclosure.

FIGS. 9A and B illustrate magnified views of the optical element as illustrated in FIG. 8 in accordance with the present disclosure.

FIG. 10A illustrates an embodiment of an optical element having a vertically movable upper first nanostructure disposed over a second and different nanostructure in accordance with the present disclosure.

FIG. 10B illustrates an embodiment of an optical element having a laterally movable upper first nanostructure disposed over a second and different nanostructure in accordance with the present disclosure.

FIG. 10C illustrates another nanostructure that may be used as either the first nanostructure, the second nanostructure, or both first and second nanostructures of optical elements as illustrated in FIG. 10A or B in accordance with the present disclosure.

FIG. 11A illustrates a simulated transmission spectrum of an optical element as illustrated in FIG. 10B in accordance with the present disclosure.

FIG. 11B illustrates a simulated transmission spectrum of an optical element as illustrated in FIG. 10B in which the first nanostructure is displaced by ½ a cell pitch with respect to the second nanostructure compared to FIG. 11A in accordance with the present disclosure.

FIG. 12 illustrates an embodiment of a tunable or switchable optical element in accordance with the present disclosure.

FIG. 13 illustrates a change in the simulated absorbance spectrum of a switchable optical element as illustrated in FIG. 12 in accordance with the present disclosure.

FIG. 14 illustrates experimental reflectivity spectra of an optical element having and lacking an overlaying superstrate layer in accordance with the present disclosure.

FIG. 15 illustrates embodiments of an optical element in which the distance between the metallic features of a nanostructure and the ground plane may vary in accordance with the present disclosure.

FIG. 16 illustrates simulated transmission spectra of an optical element as illustrated in FIG. 15 in which the distance between the metallic features of a nanostructure and the ground plane may vary in accordance with the present disclosure.

FIG. 17 illustrates experimental reflectivity spectra of an optical element as illustrated in FIG. 15 in which the distance between the metallic features of a nanostructure and the ground plane are varied in accordance with the present disclosure.

FIG. 18 illustrates an embodiment of an optical element that may act as a plasmonic absorber in accordance with the present disclosure.

FIG. 19 illustrates an embodiment of a switchable optical element in accordance with the present disclosure.

FIG. 20 illustrates an embodiment of a tunable optical element in accordance with the present disclosure.

FIG. 21 illustrates experimental relative reflectivity spectra of a switchable optical element as illustrated in FIG. 19 in accordance with the present disclosure.

FIG. 22 illustrates an embodiment of an array of circular nanostructure metallic elements in accordance with the present disclosure.

FIG. 23 illustrates an embodiment of a patterned ground plane of an optical element in accordance with the present disclosure.

FIG. 24 illustrates simulated absorbance spectra of an optical element having an array of circular nanostructure metallic elements as illustrated in FIG. 22 and a patterned ground plane as illustrated in FIG. 23 in accordance with the present disclosure.

### DETAILED DESCRIPTION

Before the devices and methods presented herein are described, it is to be understood that the embodiments described are not limited to the particular processes, compositions, or methodologies described, as these may vary. It is also to be understood that the terminology used in the description is for the purpose of describing the particular versions or embodiments only, and is not intended to limit the scope of the invention.

It must be noted that, as used herein, and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. Although any methods similar or equivalent to those described herein can be used in the practice or testing of embodiments of the present invention, the preferred methods are now described. All publications and references mentioned herein are incorporated by reference. Nothing herein is to be construed as an admission that the invention is not entitled to antedate such disclosure by virtue of prior invention.

As used herein, the term “about” means plus or minus 10% of the numerical value of the number with which it is being used. Therefore, about 50% means in the range of 45%-55%.

The terms “filter” or “optical filter” as used herein are used to describe any frequency selective optical element that is able to discriminate between electromagnetic energy of various frequencies or wavelengths by selectively absorbing, reflecting, or transmitting one or more frequencies or wavelengths or frequency or wavelength bands. Examples of commonly used filter functionalities include but are not limited to the following: narrowband transmission, wideband transmission, narrowband reflection, wideband reflection, narrowband absorption, high pass, low pass. The transmission, reflectance and absorbance spectra of a given filter over a range of frequencies or wavelengths are known as its “spectral characteristics.”

“Effective medium” as used herein describes a synthetic optical material having structure with a characteristic feature size is much smaller than a wavelength of affected radiation, which structure is said to “subwavelength.” Because a structure is subwavelength, the device as a whole may interact with radiation as if it had an average permittivity and permeability that are not found in any natural material. It is said to be an “effective medium.”

The term “metamaterial” refers to a complex material having collective optical properties of a subwavelength fabricated structure that is subject to mathematical design, in some cases for the purpose of obtaining properties not found in nature. The electromagnetic properties of metamaterials are generally determined based on the geometry and synthetic arrangements of patterned metal layers or patterned dielectric layers of the material. Metamaterials may, for example, possess absorptions for certain frequencies of radiation that are not found in the material ingredients, and as such, these properties are related to the structure, which is sometimes called the microstructure or nanostructure because of its small scale. The patterned metal layers or patterned dielectric layers may be generally referred to as patterned nanostructures.

The term “SRR metamaterials” where SRR denotes “Split Ring Resonators” will be used herein to refer broadly to metamaterials that include geometries of metal areas on a substrate and can include patterns where no rings as such are evident. A great variety of such structures are now known to the art, aimed at different useful optical characteristics or devices.

“Plasmonic” as used herein refers to physical mechanisms involving the interaction of electromagnetic fields with collective excitations of electrons in metals. Because electron waves in metals are of much shorter wavelength than electromagnetic waves of the same frequency, the use of plasmonic mechanisms tends to compress the functional volume of devices so they can be very compact, i.e., much shorter than the wavelength of the light involved.

“Plasmonic perfect absorber” or “PPA” is an exemplary metamaterial device that is reflective for most wavelengths but displays strong absorption of certain specific wavelengths depending on exact parameters. A “reconfigurable plasmonic mirror” or “RPM” is a dynamically tunable or switchable PPA.

The terms “tunable” or “dynamically tunable” as used herein are used to describe filters whose spectral behavior is subject to being continuously adjusted over a range of values by application of an external signal or impetus such as an electrical signal.

The term “switchable” as used herein is used to describe an optical filter element whose spectral characteristics are subject to being altered by application of an external signal or stimulus from a first spectral characteristic to a second spectral characteristic without necessarily transitioning continuously through intermediate states.

As used herein, the terms “discontinuous spectral switching” or variations thereof denote this kind of discontinuous reorganization of the spectral characteristic of a filter, wherein the spectral characteristic is dynamically altered from one pattern to a second different pattern without necessarily transitioning through intermediate states.

“Microelectrical mechanical systems” or “MEMS” refers to a body of technology involving microelectronic fabrication, lithography, etching, etc. to create extremely small moving parts by micromachining silicon and other materials.

“MWIR” means mid wave infrared band, about 3 μm to 5 μm wavelength.

“LWIR” means long wave infrared band, about 8 μm to 12 μm wavelength.

“P polarization” is used to describe electromagnetic waves with an electric vector parallel to the surface.

“S polarization” is used to describe electromagnetic waves with an electric vector normal to the surface.

Filters are key optical components throughout the electromagnetic spectrum, and dynamically tunable or switchable filters are important for many applications. Depending on the wavelength range, diverse materials and structures have been used to construct filters based on known principles. Filters for the mid-infrared (mid-IR) range (2-15 micrometers wavelength) are of importance for communications, imaging, microscopy, spectroscopy and many other applications. Mid-IR optical devices tend to require special materials, and generally speaking, most methods used to create tunable filters at other wavelength ranges do not apply in the mid-IR due to the natural limitations of materials used at these frequencies. Therefore, achieving tunability or switchability in the mid-IR has been difficult.

Recently, IR filters and related devices have been constructed based on the technology of electromagnetic metamaterials. Electromagnetic metamaterials are synthetic composite media whose electromagnetic properties are due to sub-wavelength scale structural features rather than the inherent properties of atoms, molecules, glasses, or crystals of natural materials. SRR metamaterials are a subclass of metamaterials which include a pattern of metallic elements on a substrate and can be predominantly substrate with patterns of metal on a minority of the surface of the substrate or predominantly metal with patterns of holes or other lines or apertures in the metal. Metamaterials can display electromagnetic and optical properties that are not found in any natural materials and can be designed for particular uses. The structural features of most metamaterials are fabricated to be much smaller than a wavelength of electromagnetic radiation at the frequency of use. The properties of these composite materials are therefore not resolved based on individual structural features. Rather, the optical properties of the material result from the collective interaction of the material and its numerous structural features with the electromagnetic radiation. A variety of different metamaterials structures are known for application to different frequency ranges. Because metamaterials rely on structural features that are a fraction of the size of the wavelength of electromagnetic radiation of use, reduction in scale has proven challenging as the filtered radiation has moved from longer wavelength applications (microwaves or RF) towards shorter wavelengths (millimeter waves, infrared or visible). Many metamaterials have now been realized by use of the well developed fabrication techniques available from the microelectronics industry, and even exotic properties such as negative refractive index, which is not known in any natural materials, have been demonstrated in metamaterials.

One subclass of electromagnetic metamaterials are based on designs for “split ring resonators” (“SRR”). Each SRR unit cell includes two surface components, a metal area and the substrate area, and the simplest SRR is a ring of metal with a gap in the ring that is deposited on a dielectric or semiconductor substrate. The substrate is generally selected from materials that are dielectric or semiconductor and low loss or transparent at the desired wavelength. The permittivity (∈) of the metal ring is negative as typical of all metals, and magnetic permeability of metals is typically zero. Non-zero (μ) values for the collective structure can be designed by the geometry of the metal lines or areas. SRR structures may also be squares, crosses, loops, bars, or various other geometrical patterns of conducting metals in dielectric substrates. At high frequencies, the gap provides capacitance and the loop provides inductance, so the metamaterial will respond to appropriate wavelengths of radiation with resonances that may selectively enhance absorption, reflectance, or transmission in ways that can be designed mathematically using various known computational techniques. Since SRR structures are typically 5× to 500× smaller than the wavelength of electromagnetic radiation of use, optical measurement of the metamaterials gives the appearance of novel bulk properties. For example, the structure scale of an SRR for use at a wavelength of 10 micrometers may include repeated pattern of cells where each cell is 1-2 micrometers and the features within each cell can be on the order of 0.05 to 0.5 micrometers.

SRR metamaterials have been useful for the design of infrared filters, and a wide variety of spectral characteristics have been demonstrated in the IR range including absorption notch filters, transmission passband filters, edge filters, stopband filters, and others using patterns of metallic microstructures on dielectric substrates. In addition so-called “Babinet filters” or complementary filters in which metal films are disposed as a majority of the 2D area patterns on a dielectric substrate with open spaces forming a minority of the area have been used as transmission notch filters.

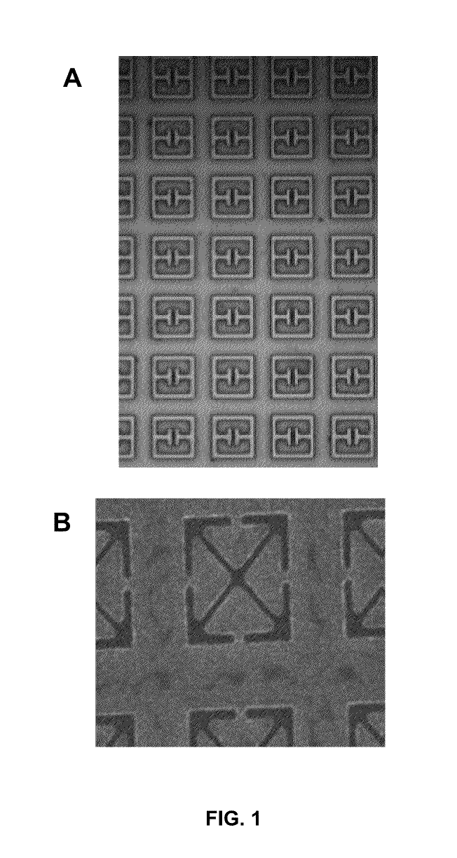

Various embodiments are directed to materials for dynamic filtering of EM radiation in the IR band through transmission filters such as those illustrated in FIGS. 1A and 1B. Examples of patterned nanostructure devices based on split ring resonators (“SRR”) for use in the IR are shown in FIGS. 1A and 1B. FIG. 1A shows an exemplary SRR design in which patterns of thin metal lines disposed on dielectric or semiconductor substrates to form split rings that are designed mathematically to provide resonances under electromagnetic (“EM”) radiation. The overall dimensions of each SRR unit cell are designed to be less or much less than the wavelength of the EM radiation irradiating the metamaterial. The SRR unit cells are analogous to artificially designed “atoms” and generally may be structured on a scale that is much smaller (about 5 to about 500 times smaller) than the resonant wavelength, due to the lumped inductance and capacitance, which are due to their structure as metallic patterns or other structural features. For example, the structures shown in the array of SRR cells in FIGS. 1A and 1B are about 1/10 the size of the design wavelength for resonant interaction. For a narrowband filter with center wavelengths of about 10 micron, the SRR unit cell may be on the order of about 1 μm to about 2 μm, with smallest features within each individual unit cell being about 50 nm to about 100 nm. FIG. 1B shows an exemplary SSR cell having specific SRR designs that are 1.6 μm square cells of gold areas on a dielectric substrate, which in this case results in a resonant transmission bandpass at a wavelength of about 9 μm.

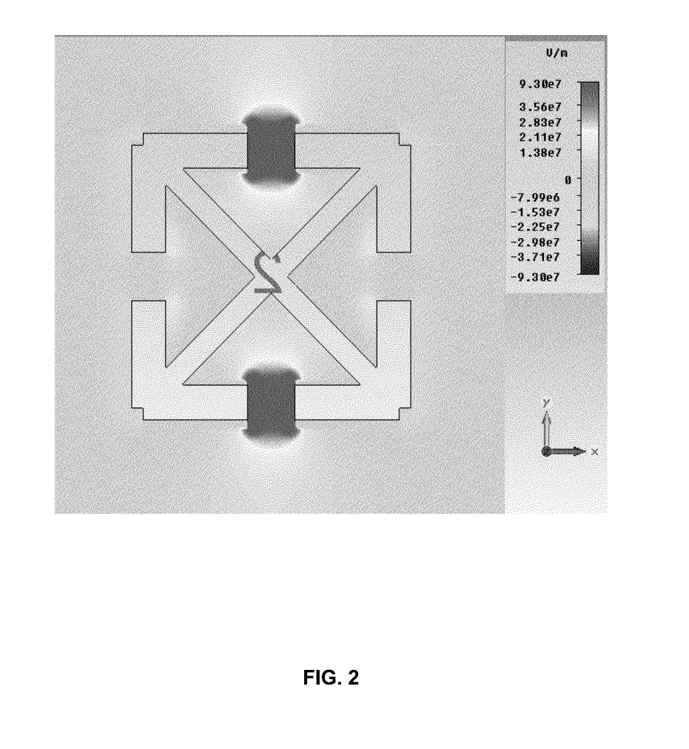

FIG. 2 also illustrates the electrical fields generated by the SRR of FIG. 1B, and indicates that the gap in the ring of such split-ring resonators is a locus of enhanced electric field strength. Even for patterns that are not rings with well-defined gaps, it is possible to design metamaterials in which the electric and magnetic fields surrounding the patterned nanostructure layer are concentrated in certain regions. This is significant because, due to the enhanced electric and magnetic fields the resonance of such cells and collection of cells will be particularly sensitive to the substrate permittivity and permeability, which together yield the refractive index, as well as the permittivity and permeability of the upper medium in those regions. Thus, the resonant frequency or frequencies of the SRR structures may be altered by substituting or altering the index of the substrate or the upper medium. Generally, the patterned nanostructures such as those illustrated in FIGS. 1A and 1B are suitable for transmission filtering and act to absorb or transmit particular wavelengths while allowing others to pass, and to achieve this the structural scale of must be smaller than the wavelength of transmission or absorption.

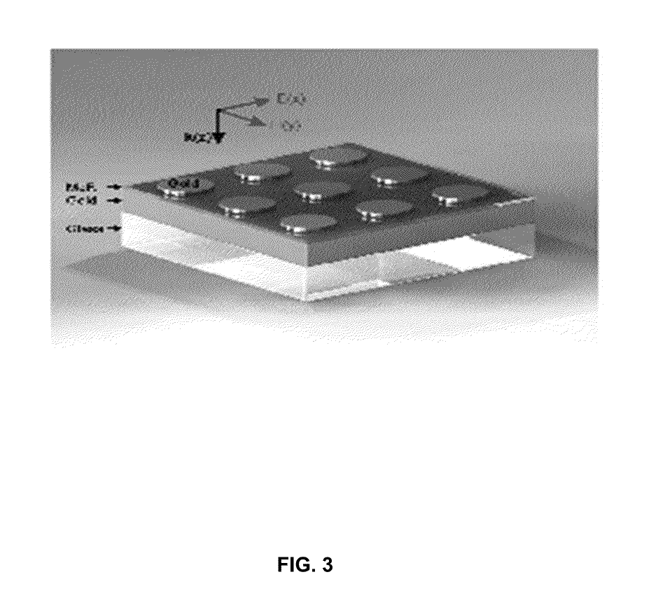

Other embodiments are directed to dynamic filters for EM radiation by reflected EM radiation. For example, metamaterials such as those illustrated in FIG. 3 are generally more suitable for filtering reflected light. FIG. 3 shows a metamaterial that includes an array of metal cylinders composed of a gold film, a thin dielectric spacer layer, and a solid groundplane of gold or another metal. Because the height of the cylinders is very small, typically less than 50 nm, these components may generally be considered 2D structured films, and in various embodiments, these shaped films may be circular, as shown, or have an oblong, circular, oval, square, rectangular, triangular, cruciform, regular polygonal, irregular polygonal, or any other shape known in the art. FIG. 3 also illustrates an exemplary embodiment of a two layer device having a top layer of including a patterned nanostructure with shaped films and a bottom layer that is a ground plane made, for example, of gold in the case pictured. In other embodiments, the ground plane may be any reflective metal such as, but not limited to gold, silver, copper, platinum, tungsten, aluminum, and the like. The top and bottom layers are separated by a spacer, which could be a solid dielectric film, a gas such as air, or a liquid. The distance between the top and bottom layers is set by the spacer and, generally, allows for a electromagnetic coupling of the ground plane and the patterned nanostructure layer. The thickness of the spacer, which is a critical parameter, may vary among embodiments and can be tailored to maximize absorption of the particular wavelengths.

The exemplary structure in FIG. 3 would be expected to behave similarly to a metal mirror over a broad range of wavelengths. However, as one example, a structure such as the one illustrated in FIG. 3 having metal foil cylinders with a diameter of 0.35 μm would be expected to absorb light at a narrow band of wavelengths near 1.6 μm in the near IR because of the electromagnetic coupling between the disk array and groundplane layers and the specific distance between them determined by the dielectric or air filled space. Thus, the mirror of FIG. 3 reflects most wavelengths but does not reflect EM radiation near 1.6 μm, which it absorbs. When electromagnetic radiation is incident, the structure taken as a whole behaves like an artificial material which is shiny and reflective except at one or more frequencies where it strongly absorbs light. The absorptions are engineered and are not necessarily those of any natural material—rather they are determined by the total structure with its subwavelength features.

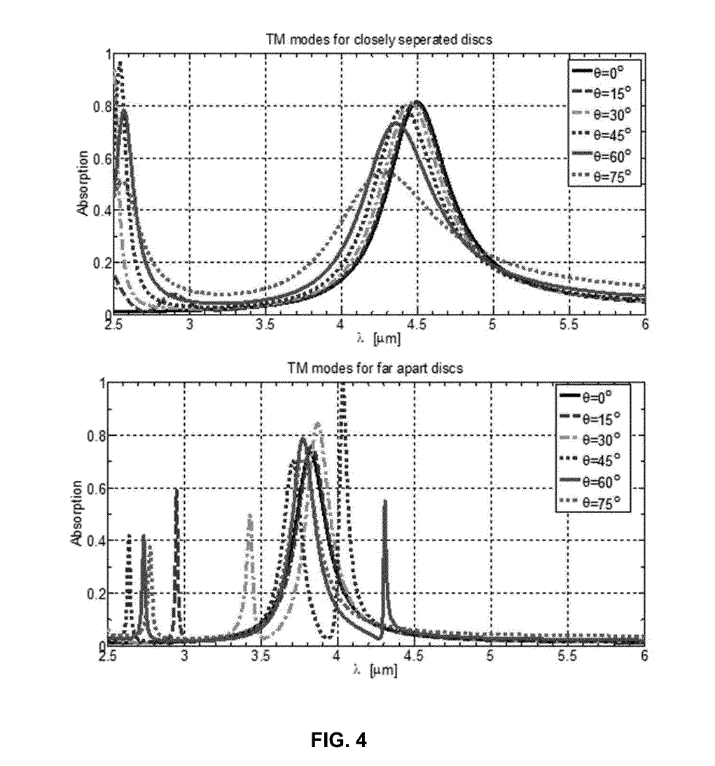

The device absorbance spectrum of materials such as those illustrated in FIG. 3 can be approximately independent of angle of incidence. This has practical advantages because, in various embodiments, such reflective devices can be used at a 45° angle or any other angle relative to the incident light with no, or very little, loss of efficiency or change of characteristics compared to their use at normal incidence. However, the degree of angle dependence relates to the geometry and in particular how closely spaced the periodic array of elements or cells may be. FIG. 4 shows modeling and simulation of the metamaterial filter of FIG. 3 using electromagnetic computational software. In particular, a material as illustrated in FIG. 3 having a ground plane of a Drude metal (thin film gold) with a plasma frequency of 1.4×10¹⁶ per second, a collision frequency of 4.0×10¹³ per second bulk, and a thickness of 30 nm to 80 nm, gold foil disks having a radius of 0.35 μm and a pitch about 1100 nm, and a spacer having a thickness of about 30 to about 100 nm, ∈ of 1.9, lossless in 3 μm to 5 μm wavelengths. This data shows that resonant wavelength is primarily determined by the diameter of the disks. But for different designs with the same diameter, the spectrum is almost independent of angle if the disks are very close together, for example having a spatial period of about 0.1% to about 20% of the metallic element diameter. While for disks of the same diameter that are spaced further apart (for example having a spatial period of about 50% to about 100% of the metallic element diameter), the resonant frequency remains roughly the same, but the isotropic property breaks down. The independence of device response to incident radiation angle or polarization may be further improved if either the metallic elements have different diameters in the x- and y-dimension (for example, ovals, rectangles, and cruciform shapes having unequal arm lengths) or if the spatial periodicity of the elements differs in the x- and y-dimension.

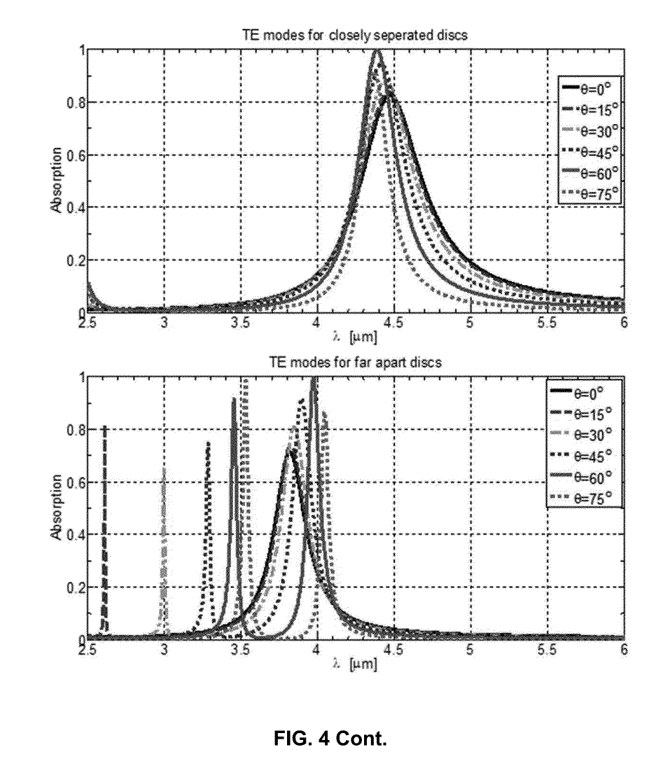

In further embodiments, the shape of the disks may be altered to achieve improved, or even essentially perfect, angle independence and polarization independence. For example, FIG. 5 shows exemplary designs expected to achieve optimized angle independence and polarization independence. FIG. 5A shows the base line array design as described above with evenly spaced circular disks. The circular metallic elements have a diameter in the x dimension that is the same as the diameter in the y dimension. Additionally, the x dimension spatial period length is about the same as the y-dimensional spatial period length. In the embodiment illustrated in FIG. 5B, the disks have an oblong or oval shape, and thus have an x-dimension diameter that differs from the y-dimension diameter. In the embodiment of FIG. 5C, the x dimension spatial period length differs from the y-dimensional spatial period length. While FIGS. 5A-C shows particular examples of modified materials, the periodicity and shape of the disks of a patterned nanostructure may be modified in nearly any way. For example, in various embodiments, the metal elements of the patterned nanostructure may be circular, oval, square, triangular, hexagonal, or any shape, and these foil components may be evenly spaced or have different spatial periodicity along the X and Y axes. By adding these asymmetric degrees of freedom to the design, which allow the cell structures to be slightly different in the X and Y directions or the spacing of the rows and columns of cell to be slightly different in the X and Y directions, the designer may be able to optimize and perfect the angle and polarization independence of the spectral characteristics. In practice this is effected by the use of computational software.

The metamaterials described above and illustrated in FIGS. 1, 3, and 5 can be made by any means. For example, in some embodiments, these metal components may be recorded by photomask lithography or higher resolution e-beam lithography or deep UV lithography. Recent fine scale lithographic technology has been developed that has allowed unit cells to become even smaller, having patterns that generate resonance frequencies in the range of 30-100 THz which corresponds to 3-10 micrometers wavelength, for which designs the unit cells are on the order of 0.3-2 micrometers. The spacing between the cells, as discussed above, may be only 50-200 nm to achieve angle and polarization independence. The e-beam resolution required for such cells, able to define features on the order of 0.05 micrometers or less, is now available.

We now discuss wavelength tunable devices. For THz wavelength metamaterials, the mechanism of tunability generally has depended on controlling the substrate permittivity and permeability by means of semiconductor charge depletion. However, tunable/switchable filters have not proven easy to achieve at mid-IR wavelengths by an extension of the same technology. Dynamic tuning is achieved by either modulating the refractive index (n) of the material, for example by use of dynamic material properties such as electrical modulation of charge carrier density in semiconductors, or liquid crystals, or some other dynamic material property, or alternatively by changing a dimension or position via some type of mechanical actuation or moving parts. At typical mid IR frequencies, significantly altering the refractive index (n) in available materials may become increasingly difficult because the properties of the materials commonly used in IR devices, such as semiconductors, glasses, or crystals, do not allow significant variation of their index properties. Thus as a practical matter, dynamic tuning of semiconductor and related materials is limited to frequencies below 1-2 THz. On the other hand, types of materials that are known to be index tunable such as liquid crystals are typically not suitable for IR filters because they are too lossy.

For example, the permittivity of GaAs can be changed at 1 THz by carrier density depletion in a doped layer of the semiconductor. However, this fails to work effectively at 30 THz because this frequency is above the plasma frequency of the charge carriers, so they do not follow the electric field oscillations. Thus, a mechanism for tuning that has been effective in metamaterials designed for 1 THz, will not work at 30 THz. Generally, effecting substantial changes in refractive index by solid state mechanisms has proven difficult in the infrared. Other suggested tuning mechanisms, such as the use of stretchable substrates, are dubious for infrared optics, especially those that are intended for rugged or vibration prone environments.

In addition to the substrate and metal components, the space immediately above the device plane can be important because electric and magnetic fields associated with the device plane extend some distance away from the surface of the material. For most metamaterial devices, the medium through which the electric and magnetic fields extends above the device plane (the “upper medium”) is air, but in principle, the upper medium could be a third material and tuning of the a metamaterial device may be achieved by modulating the electric and magnetic fields by means of repositioning an upper medium or superstrate placed above the nanostructured metal plane. Thus, embodiments of the invention are directed to metamaterial devices that include an upper medium that can be modified to influence the properties of the underlying metamaterial device. In general, for tunability at infrared frequencies, it is much more effective to relocate a high index medium closer to or farther away from the metal structured plane than it is to alter the material properties without mechanical motion.

Various embodiments of the invention are directed to optical elements and other device that include a metamaterial component and an upper medium that can be modified to alter the electric and magnetic fields associated with the metamaterial device. In such embodiments, the upper medium may overlay at least one face of the metamaterial device, and may be positioned to interact with electric and magnetic fields (“electromagnetic” in aggregate) extending away from the device plane of the metamaterial device. Such optical elements may be employed for use as transmission filters, and in some embodiments, optical elements including a patterned nanostructure component and an upper medium may be electromagnetically coupled to a ground plane to create a reflective optical element or device.

The upper medium may be composed of any material, and in certain embodiments the upper medium may have a different index of refraction than the metamaterial device. For example, in various embodiments, the upper medium may be a semiconductor wafer, glass, or crystal, and in certain embodiments, the upper material may be a second patterned nanostructure. Similarly, the upper medium in such embodiments, may be modified by any means. For example, in some embodiments, the upper medium may be positioned to allow for vertical actuation of the upper medium relative to the patterned nanostructure device, and in other embodiments, the upper medium may by positioned to allow for lateral actuation.

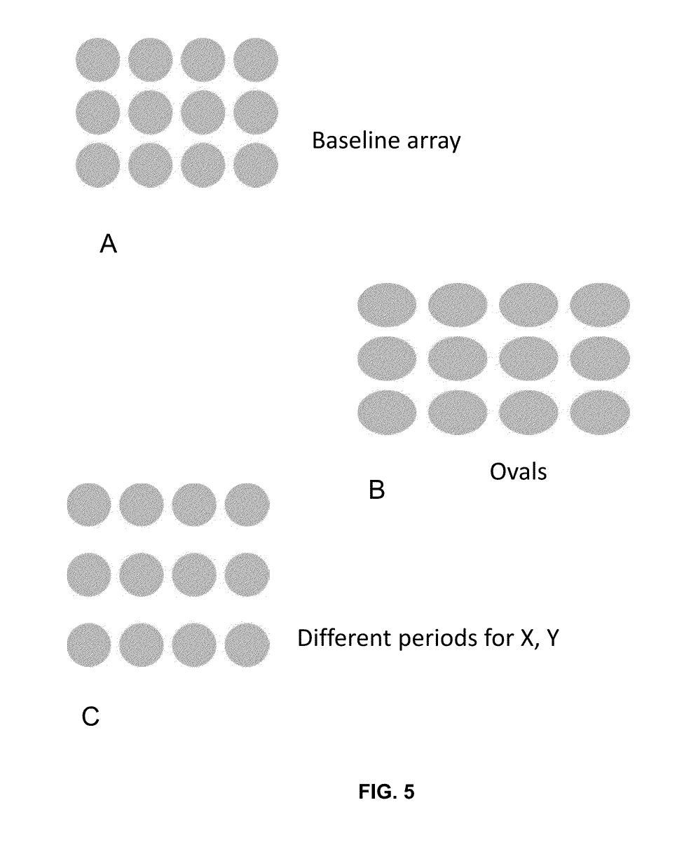

More specific exemplary embodiments include a device in which the upper medium is a semiconductor wafer that is positioned and arranged to be vertically actuated allowing the distance between the patterned nanostructure device and the upper material to be increased or decreased to tune the filtering capabilities of the patterned nanostructure device. FIG. 6 provides a model for such a device. As shown in FIG. 6, the device 1 includes a patterned nanostructure component 10 and upper medium 12 that is a wafer and is positioned to overlay the patterned nanostructure component. The arrow indicates the direction of movement of the upper medium relative to the patterned nanostructure. Vertical actuation will allow the space between the upper medium and the patterned nanostructure to be increased or decreased. In some embodiments, such devices may be tuned or switched by physically moving the secondary material 12 vertically relative to the patterned nanostructure device component 10 allowing for controlled separation over a range such as, for example, about 100 nm to about 5 μm. The upper medium 12 in of FIG. 6 is an unpatterned wafer that can be prepared from any advantageous material such as, for example, a high index semiconductor. Such devices may be useful as dynamic EM filters.

The devices of embodiments described throughout this disclosure are capable of tuning or switching the transmission, absorption, and reflection spectra of the optical element indicating that the transmission, absorption, and/or reflection spectra of the device can be modified by from about 5% to about 99% for particular wavelengths. By “tuning” is meant that the transmission, absorption, and reflection spectra is modified by up to about 100% relative to center wavelength, and in some embodiments, tuning may indicate that the transmission, absorption, and reflection spectra is modified by from about 5% to about 50%, about 10% to about 40%, about 20% to about 35% or any percent modification between these exemplary ranges. We distinguish “tuning” from “switching.” By “switching” is meant that a portion of the transmission, absorption, and reflection spectra is switching from being nearly completely absorbed to nearly completely transmitted or reflected, or vice versa. For example, in some embodiments, up to 99%, or up to 100%, of a particular wavelength may be transmitted, absorbed, or reflected, and in other embodiments, from about 50% to about 99%, about 60% to about 90%, about 75% to about 80%, or any percent between these exemplary ranges can be transmitted, absorbed, or reflected by the optical elements. Whether the device switches or tunes, a desired wavelength of EM energy is determined by the design of the optical element, and the skilled designer can produce optical elements that can switch or tune any desired wavelength based on the description provided herein, for example, by modifying the design and arrangement of metal components on a patterned nanostructure and the position of high index elements.

The amount of movement required to achieve the tuning and switching described above is extremely minimal. For example, tuning or switching can be achieved my moving an upper material relative to a patterned nanostructure, or a patterned nanostructure layer relative to a ground plane, by a fraction of a wavelength of the transmitted, absorbed, or reflected energy. For example, tuning IR radiation at a wavelength of 5 μm may require a 1% modification of a patterned nanostructure component. Therefore, vertically displacing the patterned nanostructure component by 50 nm relative to a ground plane may achieve about 50% adsorption of the 5 μm radiation. Thus, tuning and/or switching of a specific wavelength may require movement within the device of from about 0.1% to about 10% of the wavelength of the object wavelength to tune or switch the object wavelength from about 5% to about 99%. Thus, various embodiments encompass movement of the various components of the optical elements described herein from about 5 nm to about 5000 nm and, in certain embodiments, from about 5 nm to about 2500 nm, from about 10 nm to about 1000 nm, or any amount of movement between these ranges. As indicated above, such movement may be vertical or lateral depending on the design of the device and desired result, and the movement may generally be effectuated using micromechanical actuators.

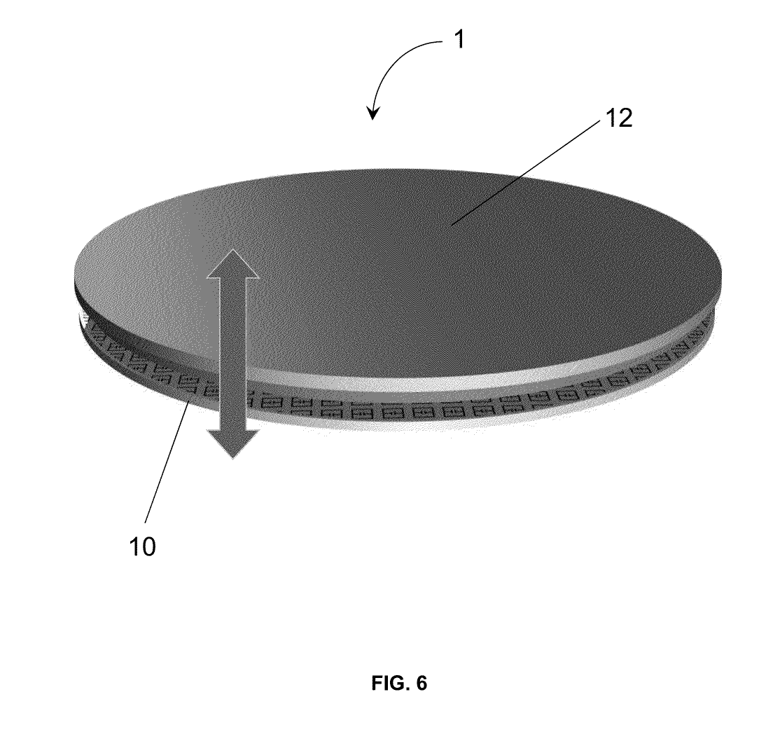

FIG. 7 shows the effect on the spectrum of standoff separations of 300 nm, 150 nm, 50 nm, and 0 nm respectively (0 means contact) for a device in which the substrate of the patterned nanostructure component and the upper medium are both diamond. These data show that such a filter can be effectively tuned from a transmission maximum at 7.2 μm to 9.5 μm. Although the second layer in this example is the same material as the substrate, it is believed that the tuning will be even greater than shown if the second layer has a relatively higher index than the substrate, and computer simulations show that the amount of tuning achieved through a given separation change may be larger if the index of refraction of the upper medium is substantially greater than the index of refraction of the substrate. For example, the change in transmission wavelength, and therefore, tuning will be greater for a device in which the substrate of the metamaterial device component is diamond (index, 2.24) and the upper medium is Ge (index, 4.2) than if the upper medium is also diamond.

In other exemplary embodiments, the upper medium may be positioned and arranged to be actuated laterally relative to the patterned nanostructure device component, and in such embodiments, the upper medium wafer may be structured to include, for example, discrete mesas, columns, or fingers that can interact with the unit cells of the patterned nanostructure device component which maintain a fixed vertical separation, such as about 10 nm to about 1000 nm between the patterned nanostructure component and the upper medium. Lateral actuation may, therefore, present alternating high index and low index (air) materials to the sensitive loci, and without wishing to be bound by theory may provide an optical element in which small lateral movements can effectively modify the properties of the patterned nanostructure component. For example, in some embodiments, the full tuning range may be accomplished by lateral microactuation of only ½ the cell pitch.

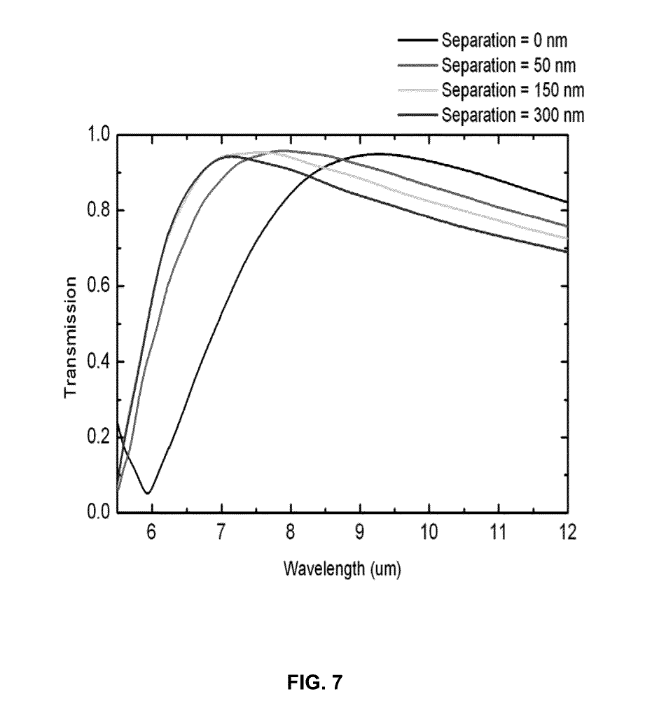

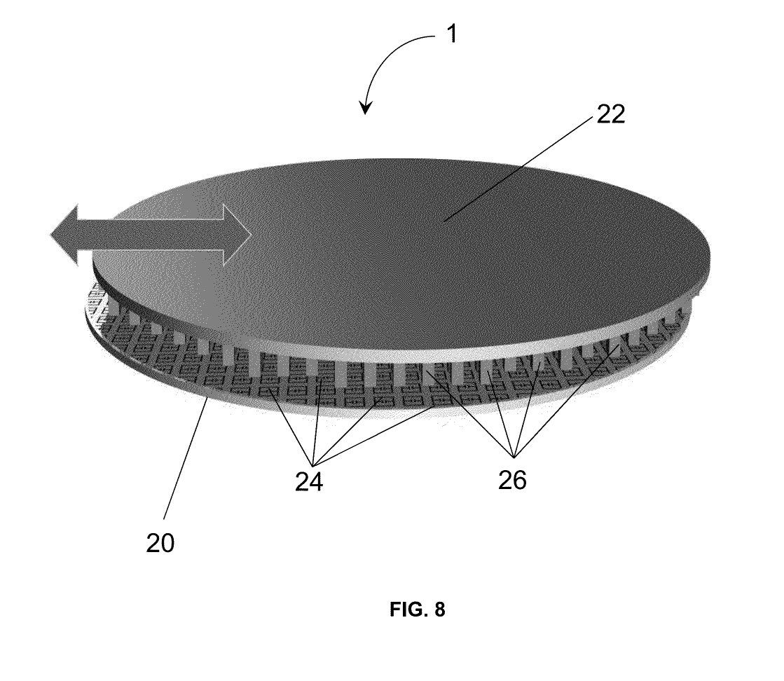

FIG. 8 an illustrative example of a device 2 of such design. The device 2 includes a patterned nanostructure component 20 and a structured upper medium 22 that includes pillars or mesas 26 designed to interact with the SRR 24 of the patterned nanostructure component 20. FIGS. 9A and 9B show a closer representation of the exemplary device of FIG. 8. FIG. 9A show the patterned upper medium 22 in a first position in which a portion of the pattern which resembles pillars 26 in this depiction contact a portion of each SRR 24 of the patterned nanostructure device component 20. FIG. 9B shows the patterned upper medium 22 in a second position after lateral micromechanical actuation that has repositioned upper medium 22 such the pillars 26 contact the patterned nanostructure device component 20 between the SRR 24. For a patterned nanostructure having SRR unit cells that are 1.6 μm squares, the movement illustrated in FIGS. 9A and 9B would be lateral movement of only about 0.8 μm.

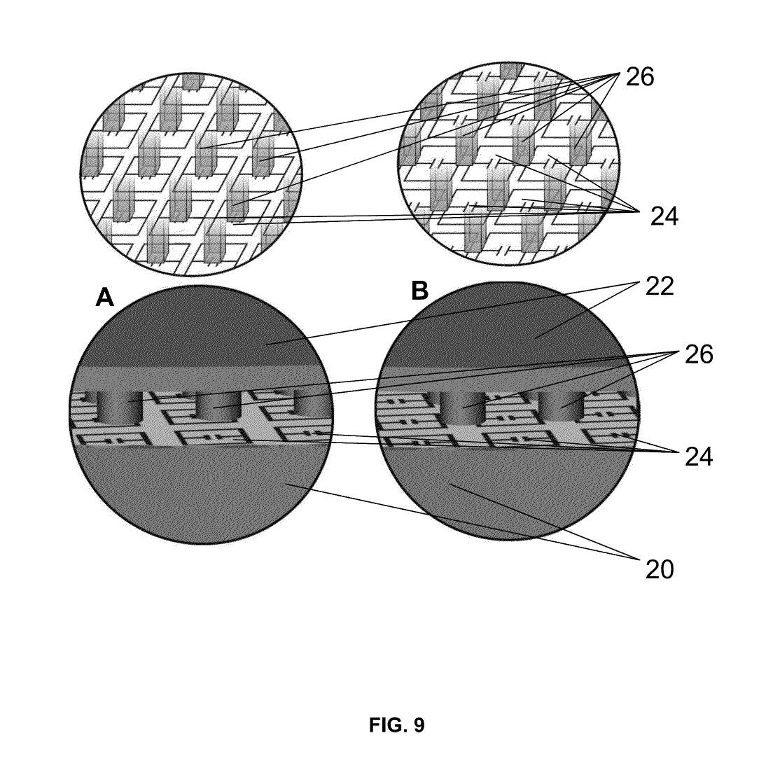

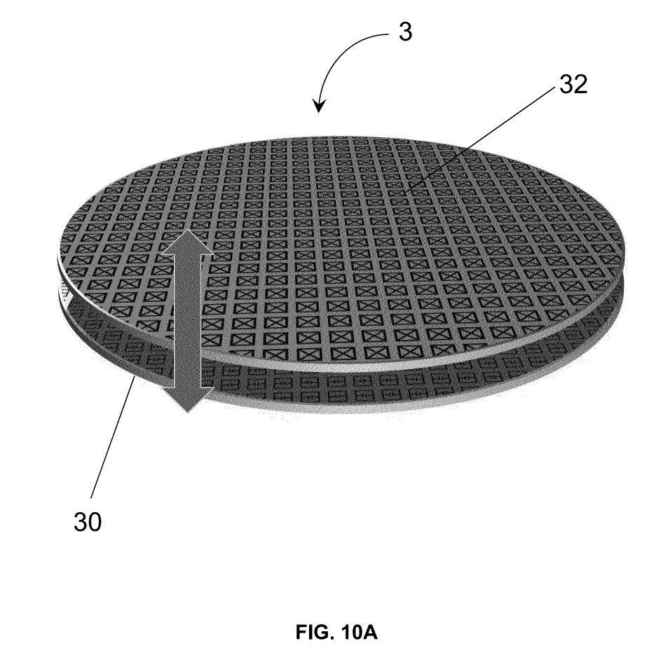

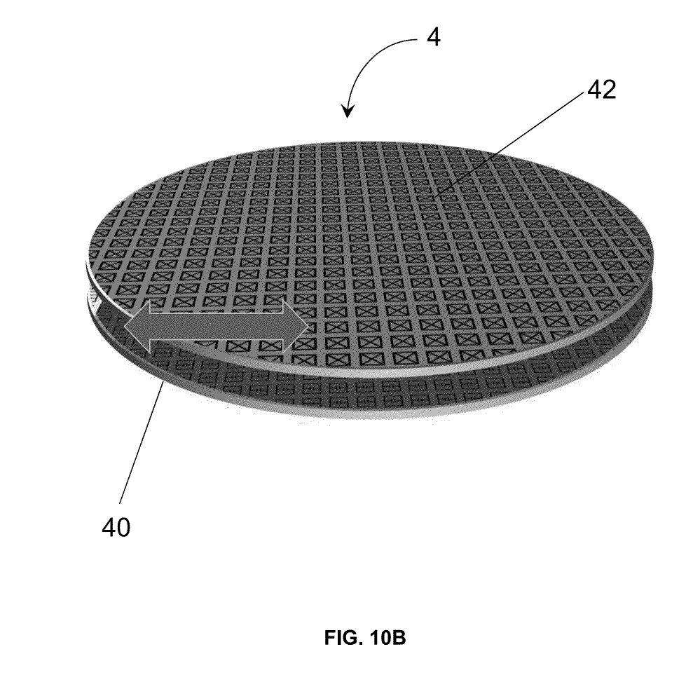

In still other exemplary embodiments, the upper medium may be a second patterned nanostructure that is positioned and arranged to be actuated vertically relative to a patterned nanostructure device, and in further exemplary embodiments, the upper medium may be a second patterned nanostructure that is positioned and arranged to be actuated laterally relative to a patterned nanostructure device. FIGS. 10A and 10B show an illustrative example of a device that includes two patterned nanostructures. As shown in FIG. 10A, such devices 3 may include a patterned nanostructure device component 30 and an upper medium that is a second patterned nanostructure 32. As indicated by the arrow, tuning may be effectuated by vertically actuating the upper medium, second patterned nanostructure 32 relative to the patterned nanostructure device component 30. Without wishing to be bound by theory, the effect of vertical actuation may be to change the gap dimension of the device thereby modifying the SRR resonance of the patterned nanostructure component and tuning the device. In such embodiments, the upper medium, second patterned nanostructure may be either identical to the lower patterned nanostructure component or the upper medium, second patterned nanostructure may be different from the lower patterned nanostructure component. Vertical microactuation of such devices may be carried out over a range of from about 10 nm to about 5000 nm.

In still further exemplary embodiments, the device may include an upper medium, second patterned nanostructure that is positioned and arranged to be moved laterally relative to the patterned nanostructure component. In such embodiments, the separation between the patterned nanostructure component and the upper medium, second patterned nanostructure may be fixed and, in certain embodiments, may be from about 10 nm to about 1000 nm. FIG. 10B shows one example of such a design. In FIG. 10B, the device 4 includes an patterned nanostructure component 40 and an upper medium, patterned nanostructure 42 that are different. As indicated by the arrow, the upper medium, patterned nanostructure may be laterally actuated to modify the properties of the patterned nanostructure component. While FIG. 10B shows an upper medium, patterned nanostructure 42 that is different than the underlying patterned nanostructure component 40 in some embodiments, the patterned nanostructure component and the upper medium, patterned nanostructure may be the same. For example, FIG. 10C shows the design for an exemplary patterned nanostructure 50 in which the lower patterned nanostructure component and the upper medium, patterned nanostructure are identical.

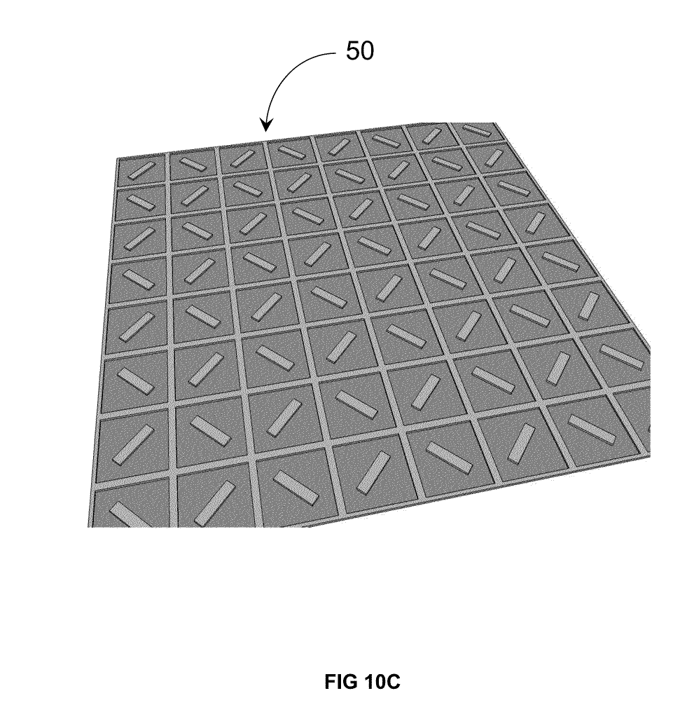

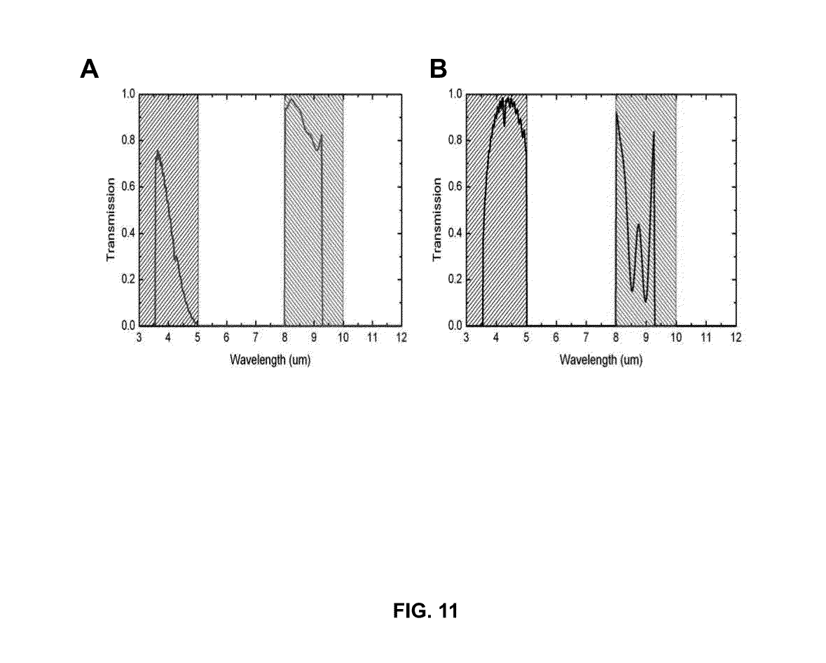

Without wishing to be bound by theory, embodiments that include an upper medium, which is itself a patterned nanostructure may be particularly well adapted to filters that are switched between initial and final states without transitioning the intermediate states, i.e., switchable filters, as indicated by FIGS. 11A and 11B. FIGS. 11A and 11B show a computer model of a device that includes an upper nanostructure and shows the effect of displacing the planes laterally relative to each other by only ½ the cell pitch. FIG. 11B illustrates that the lateral displacement of the upper nanostructure with respect to the lower nanostructure effectively reorganizes the transmission spectrum of FIG. 11A from substantial transmission at about 3 μm to about 5 μm and substantial blocking at about 8 μm to about 12 μm, to the reverse. Thus, the filter alternates between transmitting these two bands, and the lateral motion required is extremely small, on the order of a cell size, which is a small fraction of a wavelength.

Without wishing to be bound by theory, lateral actuation in which the upper medium is moved laterally relative to the patterned nanostructure component may result in periodic tuning or switching over the full dynamic range because the cell period is so small, regardless whether the upper medium is a natural material or a patterned nanostructure. Lateral actuation of a structured high index upper medium may also have the advantage that by simply moving it continuously at a constant speed in one lateral direction, the effective response of the filter can be periodically tuned, cycling over its full range whenever the displacement is equal to the cell period, which may be, for example, 1 μm. As an example, by laterally displacing the semiconductor layer relative to the patterned nanostructure layer in a continuous fashion at a rate of 10 mm per second, the filter may be tuned over its full range at the rate of 10,000 complete cycles per second. Thus, due to the very small micromechanical displacement required for wide tuning, it may be possible to effect periodic tuning of the filter at quite high speeds using a simple linear motion. In some embodiments, the mechanism of tuning comprising strong electromagnetic coupling from one patterned nanostructure layer to a second layer separated by a fraction of a wavelength, even if the second layer is simply a structured (patterned) dielectric, and in such embodiments, the micromechanical mechanism simply controls the average refractive index near the patterned nanostructure layer. Therefore, periodic tuning or switching of such structures can be effected at very high speeds.

In embodiments in which the upper medium is a patterned nanostructure, the upper medium may be identical to the material used in the patterned nanostructure component, and in other embodiments, the patterned nanostructures used in each of the upper medium and patterned nanostructure component may be non-identical or different. For example, in some embodiments, the patterned nanostructure component may have a different design, pattern, or type of patterned nanostructure than the upper medium, and in other embodiments, the upper medium may have a different array of metal components from the patterned nanostructure component. Thus, in some embodiments, the device may include a first patterned nanostructure layer and a second patterned nanostructure layer where the first patterned nanostructure layer has a different pattern than the second patterned nanostructure layer, or in other embodiments, the device may include a first patterned nanostructure layer and a second patterned nanostructure layer where the first patterned nanostructure layer has the same pattern than the second patterned nanostructure layer. In particular embodiments, the patterns may be designed to achieve specific resonances through cooperative interactions.

Without wishing to be bound by theory, two patterned nanostructure layers in close proximity may electromagnetically couple to one another strongly, with one encompassing the electromagnetic environment of the other. Therefore, two parallel layers of patterned nanostructures in close proximity may have a different net transmission/reflection spectrum than a single layer, whether the two layers are identical or different. This may lead to two-layer designs where relative lateral displacement by ½ the cell period leads to substantial changes in the net optical spectral characteristics of the assembly. In all cases, two layer patterned nanostructures may depend on the exact registration of one layer relative to the other, because of the underlying coupling of the fields, especially near the gaps of split rings. Micromechanical actuation of two patterned nanostructure layers relative to each other may also cause either dynamic tuning or substantial modification of the net filter characteristic, which can lead to advantageous types of switching behavior. Thus, a two layer metamaterial device may include metallic patterns such as SRR's or other patterns in both layers, which combine to yield resonances. These two layers may, in some embodiments, be identical patterns or, in other embodiments, different patterns designed to work together to achieve a desired filter characteristic. A very small micromechanical lateral displacement of the first layer relative to the second may be sufficient to cause a substantial change in the net spectral characteristic.

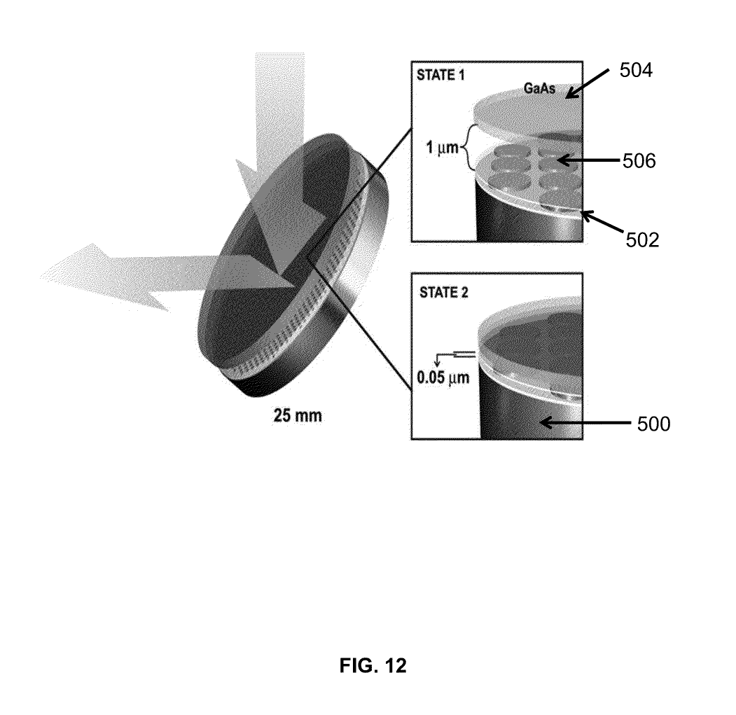

The embodiments described above are generally useful for tuning or switching transmission spectra; however, such devices may be used in conjunction with a ground plane to create a device that is useful for tuning. Various embodiments are directed to optical elements that are specifically designed for tuning the reflection spectra. For example, FIG. 12 shows an frequency tunable optical element of a particular embodiment designed to produce a reconfigurable plasmonic mirror (“RPM”). In such embodiments, the device may include a ground plane 500, patterned nanostructure component including a disk array 502, and a third component 504 that can be a membrane, wafer, or a second patterned nanostructure layer. The various components of such a device will generally be electromagnetically couple to one another to produce a device with unified transmission, absorption, and reflection spectra In certain embodiments, the third component may be a relatively high index material that is also transparent in the spectrum of interest. For example, for operation in the mid IR, the high index material may be a material such as p-doped diamond, GaAs, ZnS, Ge, SiGe, GaInP, AlGaAs, GaInAs, AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H-SiC, a-Sn, BN, BP, BAs, MN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb. In certain embodiments, the high index material may be provided in two or more segments that cover a portion of the ground plane and patterned nanostructure component.

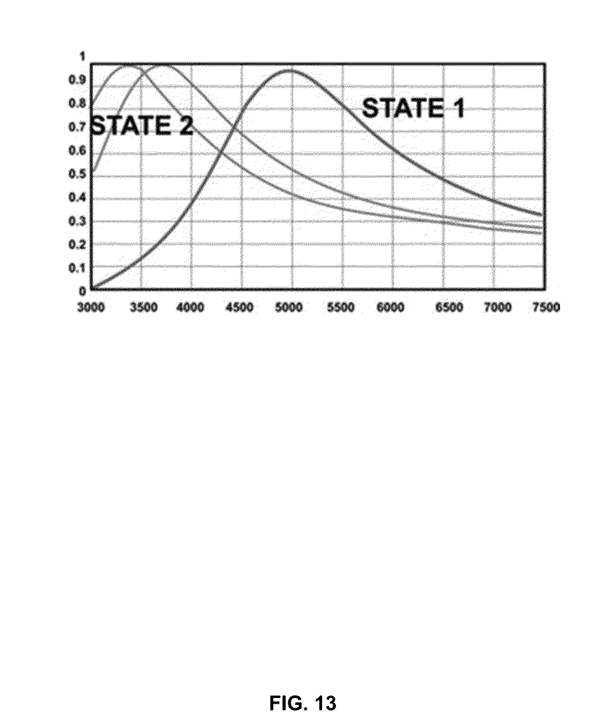

In particular embodiments, the optical elements as illustrated in FIG. 12 may be designed to tune or switch wavelengths in the mid-IR spectral region, the MWIR. For example, in some embodiments, metal foil cylinders associated with the patterned nanostructure component, such as that illustrated in FIG. 12, may have a diameter of from about 0.8 μm to about 1.0 μm and a pitch about 10% greater than the diameter. The resonant absorption wavelength for such a device is expected to be with a spectral region of from about 3 μm to about 5 μm, the MWIR. In such embodiments, the average index of the environment just above the patterned nanostructure array 502/506 may be varied by vertically altering the position of the third component bring the third component into closer or farther proximity to the patterned nanostructure plane. Even if the third component does not fill the space, the average index of the device is expected to change. For example, in some embodiments, a third component 504 of a high index material may be vertically actuated relative to the patterned nanostructure component 502, as shown schematically in FIG. 12 tuning the absorption spectrum as indicated by the simulation provided in FIG. 13. When the high index layer third component 504 is close to the patterned nanostructure component 502, about 10 nm separation, the resonance wavelength is projected to be about 5 μm. In contrast, when the high index layer third component 504 is moved farther away from the patterned nanostructure component 502 to provide a separation of about 1000 nm, the resonance tunes to a shorter wavelength projected to be about 3.3 μm. Notably, tunability from about 3.3 μm to 5.0 μm is considered by infrared optical specialists to be a large range in comparison with many other approaches known for dynamic infrared filters.

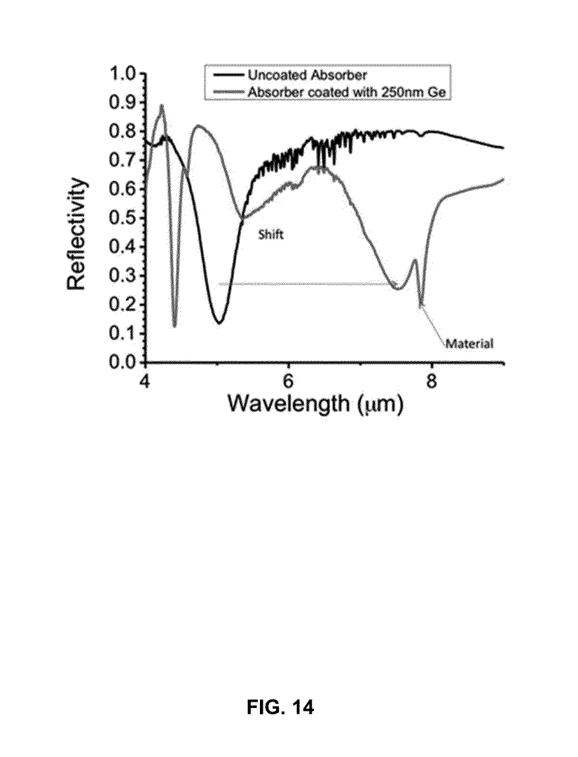

FIG. 14 shows further experimental evidence of this principle showing “before and after” measurements on said static wafer. More specifically, an optical element as illustrated in FIG. 12 having ground plane 500, patterned nanostructure component including a disk array 502, and a third component wafer 504, or “superstrate” was fabricated and the resonant absorption was experimentally determined to be about 5 μm. A 250 nm layer of Ge was then added to the wafer by being sputtered on top to simulate moving a high index superstrate closer to patterned nanostructure component. As exhibited by the data presented in FIG. 14, the absorbed wavelength shifted from 5 μm to about 7.5 μm providing 50% tunability. These models and calculations suggest that the reflectance at the unblocked wavelengths can be as high as 99%, independent of angle of incidence and independent of polarization, whereas the reflectance at the blocked wavelength can as small as 0.01%, indicating absorption of the target wavelength of as much as 99.99%. This large ratio of optical blocking, 10,000 to 1, is highly desirable for some applications of IR imaging.

The optical elements of such embodiments may generally act as a mirrors that may be placed at an angle to the light path and used in various IR optical systems. In particular, over a specified band of wavelengths, the optical element may behave similarly to a simple metal mirror, i.e., it may be highly reflective. Optical elements designed as described in FIG. 12 may absorb EM waves within a particular wavelength band, and this absorption may be dynamically tuned by moving the third component relative to the patterned nanostructure component as described above. Such devices act as a tunable waveblockers and can effectively exclude one undesired wavelength while reflecting the remainder of the IR range undisturbed. This might be useful if, for example, a laser of an unknown wavelength were present in the environment which might blind or damage a human eye or sensor. The device can exclude the laser, adjusting to its wavelength, while permitting imaging to continue at other wavelengths. Thus, various embodiments include, frequency agile sensor protection devices including the optical elements described above.

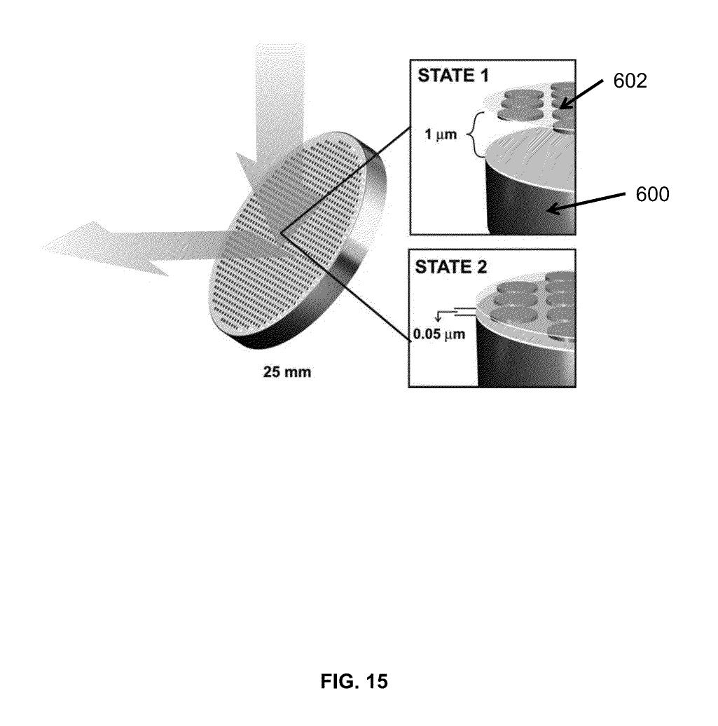

In some embodiments, the absorbance of a target wavelength may be tuned as described above. In other embodiments, it may be desirable to switch the absorption on or off while keeping its frequency fixed. Referring to FIG. 15, the ground plane and the patterned nanostructure component (nanostructured metal pattern) can be separated by any distance allowing for electromagnetic coupling such as, for example, about 5 nm to about 5000 nm, and in some embodiments, such devices may include a spacer between the ground plane and the patterned nanostructure component that can be composed of a gas, such as, air or an inert gas, a liquid, such as water, or a dielectric solid.

In a particular exemplary embodiment, the patterned nanostructure may include a disc array made from gold foil having a diameter of about 1.7 μm and a thickness of about 50 nm on a 1.8 μm pitch. The ground plane 600 may be any reflective materials such as, for example, gold and may have any thickness such as, for example, about 200 nm. The ground plane and the patterned nanostructure component may be separated by a distance of about 70 nm thereby providing a spacer composed of air and having a thickness of 70 nm. The resonant absorption of a device having the parameters described above is projected to be about 4 μm wavelength, and the absorption of about 4 μm wavelength is projected to be maximized to nearly 100% by this device essentially turning this wavelength off. When the spacer thickness or air gap is increased, the resonance is weakened, and separating the ground plane and the patterned nanostructure component by about 1000 nm, is expected almost entirely washed out resonance turning the about 4 μm wavelength on. As such, microarticulation of the gap between the layers over the range 50-1000 nm, using MEMS mechanisms, the resonance can be modulated over a very large dynamic range.

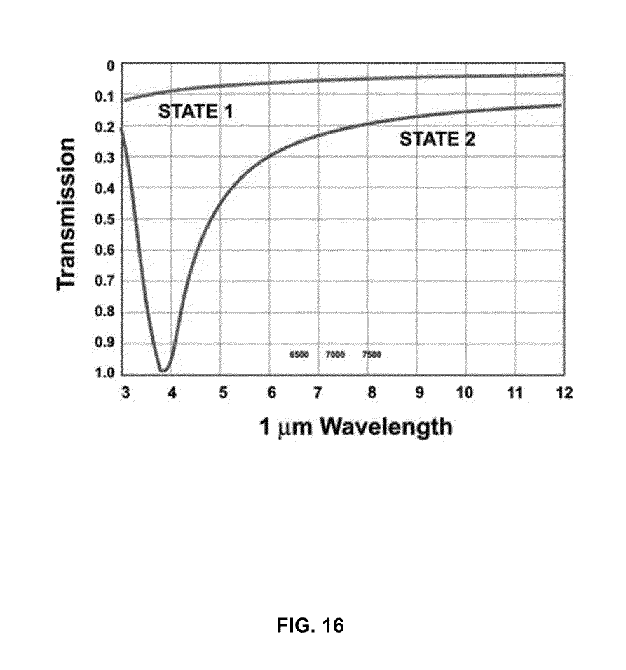

The effect is shown in the computational simulations of FIG. 16. When the ground plane 600 and patterned nanostructure component are about 1 μm apart, State 1, the absorptive resonance is deactivated. The device now behaves as a metallic mirror with high reflectance 3 μm to 12 μm. When the layers are brought close together, about 70 nm separation, State 2, the MWIR band is absorbed and mirror is expected to effectively reflect only the 5 μm to 12 μm wavelengths. The effect is that the mirror passes (reflects) 3 μm to 12 μm in State 1 but only 5 μm to 12 μm in State 2. Such functionality is of considerable potential value to the IR imaging.

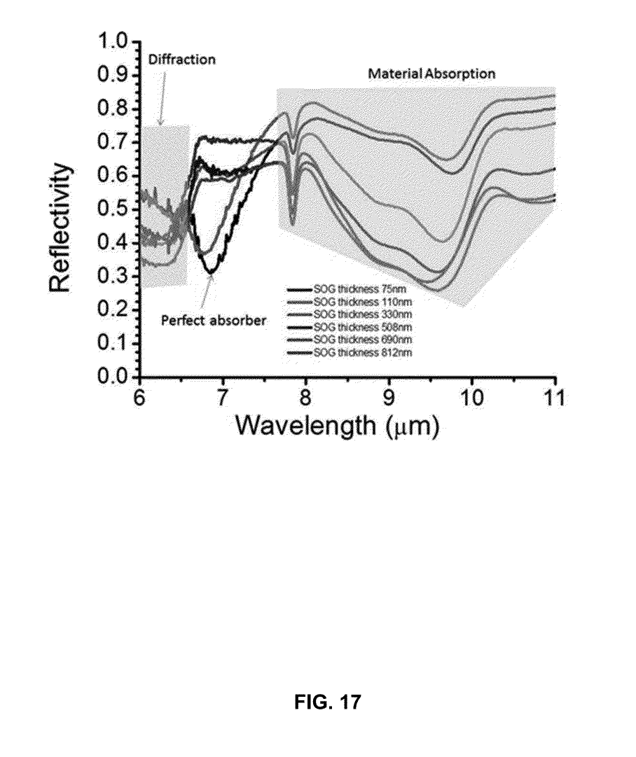

FIG. 17 shows experimental evidence validating the principle described above using fixed layers on a sequence of static wafers. A sample optical element as described in FIG. 15 including ground plane and patterned nanostructure component including a disk array, was fabricated for an absorption resonance near 7 μm. The spacer, spin-on glass, “SOG,” was spin coated onto the ground planes in a sequence of different thicknesses. Considering only the reflectance between 6.6 and 7.7 μm, the resonance is reduced and finally wiped out completely as the SOG layer thickness is increased from 75 nm to 812 nm. Illustrating that controlling the spacer thickness can optimize the resonant absorption strength or reduce it or suppress the absorption completely.

In other embodiments, resonance strength-switching same on/off can be accomplished using a fixed spacer thickness and a MEMS mechanism to electrically short out the metal components of a patterned nanostructure by, for example, connecting each metal component to a neighboring metal component, using metallic tabs. The metallic tabs can be raised or lowered by MEMS for this purpose. The plasmonic-optical absorption between the array and ground plane depends on the metal components being separate and disconnected, and the patterned nanostructure acts much like a monolithic plane of conducting metal when the metal components of the patterned nanostructure are connected, and no resonance occurs. Therefore, the resonance properties giving specific absorbed wavelengths are rendered inoperative when the metal components are connected together by metal conducting fingers. In this state the reflectance of the device is reduced to that of a planar metal mirror. When the fingers are lifted by the MEMS mechanism, the disks regain their electrical separateness and the optical resonance is activated again.

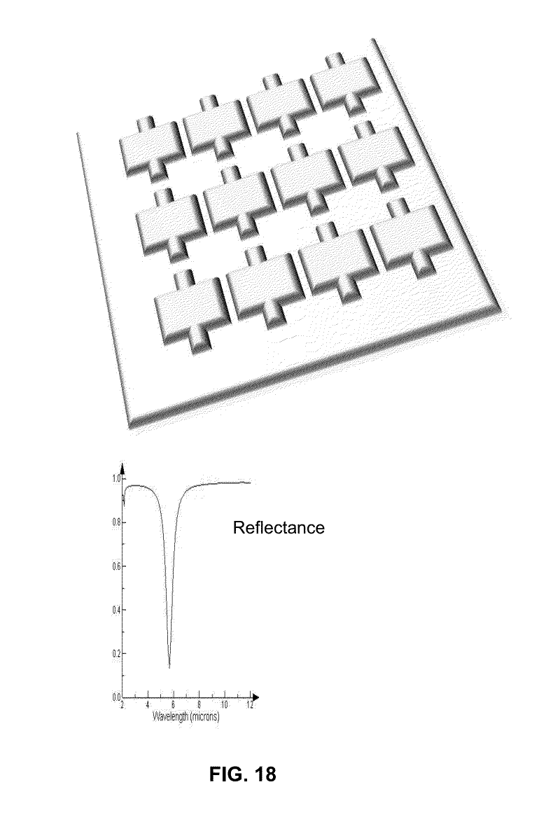

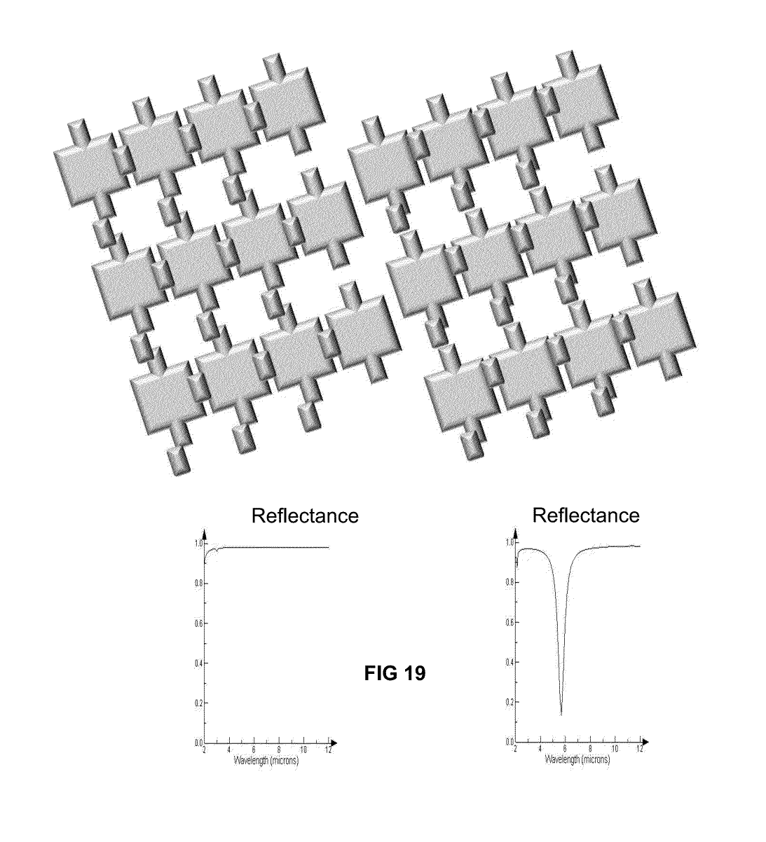

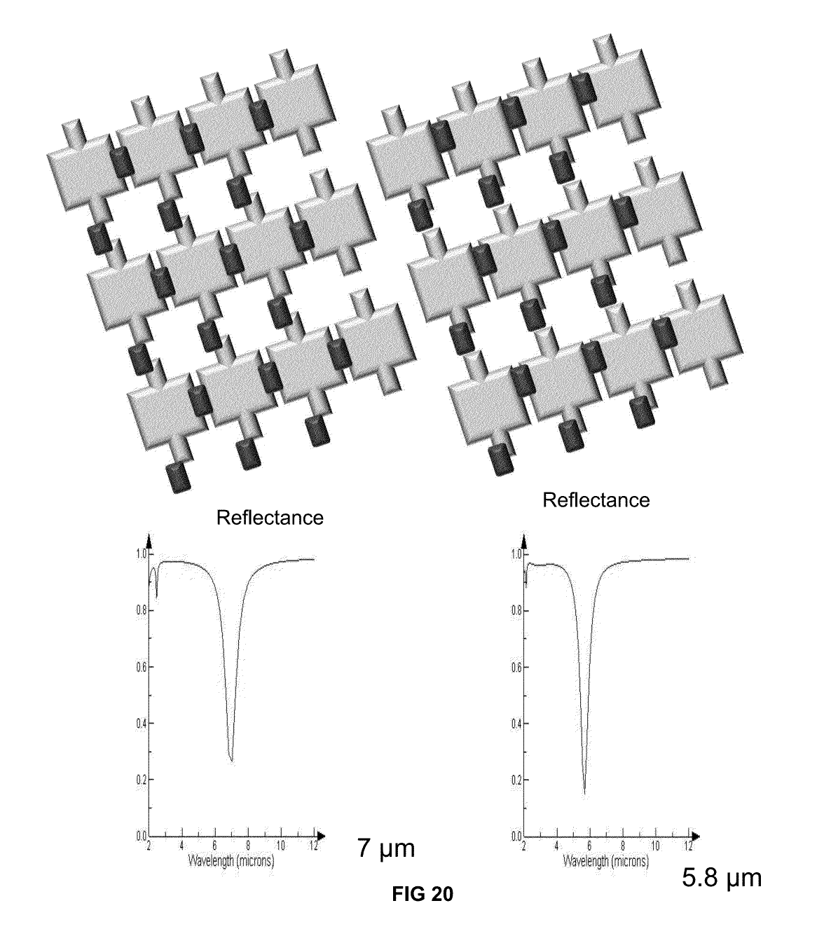

FIGS. 18-20 illustrate these concepts. Here the disk array is replaced in one example with an array of crosses, which may be advantageous in that the lateral regions near the crosses are regions where the electric field strength couping the elements to their nearest neighbors are enhanced, and so these are particularly sensitive points to influence the resonances. FIG. 18 illustrates a basic plasmonic resonator with an array of crosses. FIG. 19 illustrates a MEMS arrangement for switching the resonance on or off and FIG. 20 illustrates a MEMS arrangement for tuning the resonance.

Switching may be achieved using a device as illustrated in FIG. 19 including a ground plane and patterned nanostructure component including a cross array.

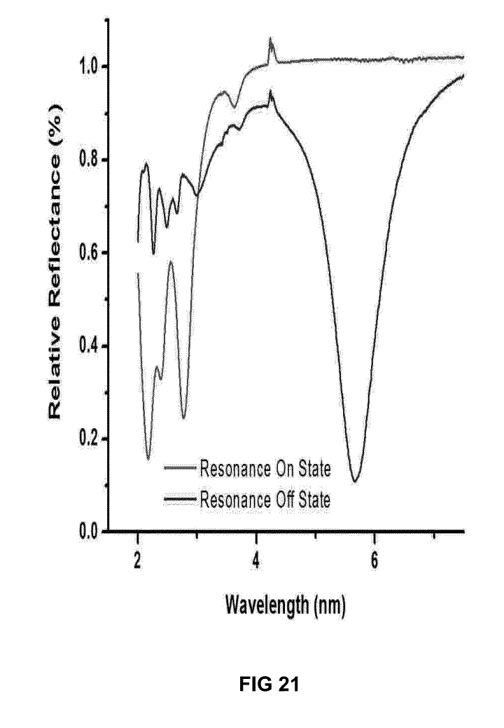

FIG. 19 provides an exemplary embodiment of the of an optical element having the design described above. Metal tabs are vertically articulated by MEMS to short out the crosses of a patterned nanostructure component or leave the crosses untouched. In this embodiment, the space between the patterned nanostructure component and the ground plane remains constant while the resonance is turned off or on, respectively. The metal tabs may be deposited on a membrane such as Si₃N₄ or Al₂O₃ and moved up and down by MEMS mechanisms driven by electrostatic forces. The optical reflectance of such an optical element would be expected to be similar to the reflectance shown in FIG. 16, State 1, when the metal tabs contact the disks of the patterned nanostructure component. When the tabs are lifted, the disks are electrically separated and the resonance is activated, providing an optical reflectance that is expected to be similar to that shown in FIG. 16, State 2. Data from an experiment illustrating this principle is shown in FIG. 21.

FIG. 20 shows that if the tabs are a high index dielectric such as Germanium instead of metal, the effect of raising or lowering the tabs will be to dynamically tune the frequency of the resonant absorption. FIG. 20 shows the computer simulation graphs of the predicted effect.

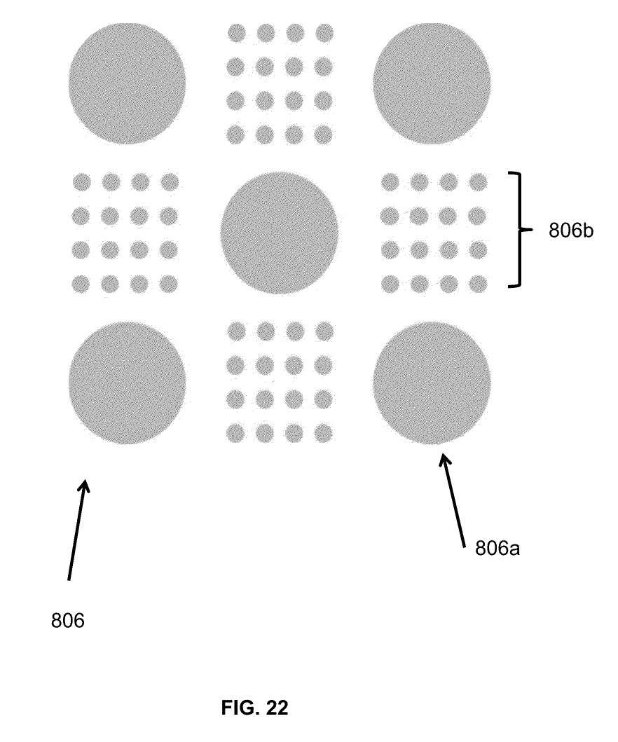

Further embodiments include optical elements that are switchable between two different absorption bands, which may be far apart in frequency. For example, an optical element can be designed that has two strong absorption bands, one at SWIR and one at LWIR. FIG. 22 shows an array of metal components 806, disks as exemplified, having different sizes arranged to provide a patterned nanostructure with different sized metal components arranged in a “supercell” design rather than a uniform array of equal sizes disks of 1n such embodiments, the large metal components 806a, disks, are expected to create a resonance at a low frequency, and the smaller, more densely packed metal components 806b, disks, are expected to create a resonance at a higher frequency. When a monolithic metal ground plane is present and separated by an appropriate fixed distance from the patterned nanostructure having the mixed disk array of FIG. 16, resonances will be observed at both the high frequency band and the low frequency band simultaneously allowing tuning and/or switching a multiple bands at the same time. Thus, in some embodiments, tuning and/or switching of both frequencies may be carried out simultaneously by moving the patterned nanostructure component relative to the ground plane as discussed above.

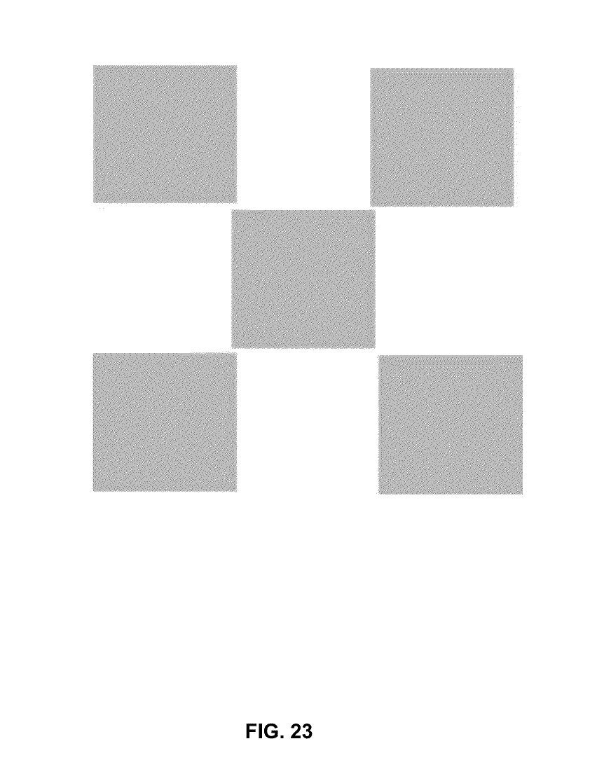

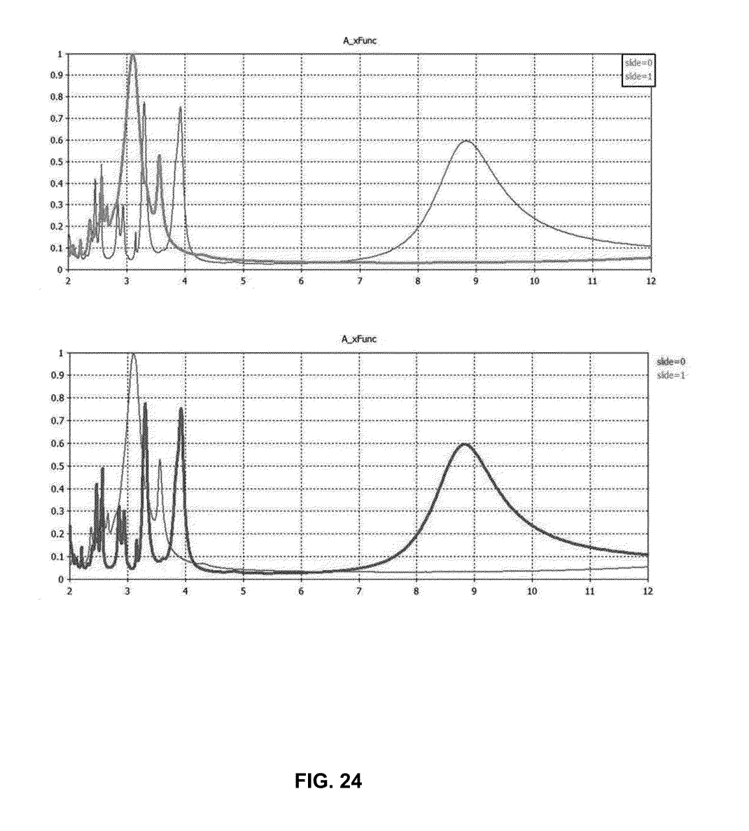

In other embodiments, the ground plane may be patterned as illustrated in FIG. 23. While the patterned ground plane of various embodiments may be patterned in any way, in certain embodiments, the ground plane may have a checkerboard pattern with metallic film areas alternating with open areas that corresponds with the pattern of the patterned nanostructure array. The period of the checkerboard ground plane, therefore, matches the period of the supercell arrangement of the patterned nanostructure. For example, the period of the checkerboard of the ground plane of FIG. 23 matches the period of the supercell illustrated in FIG. 22. In such devices, the distance between disk array and groundplane layer can be kept fixed. When the ground plane is missing under either the smaller disks or the larger disks in FIG. 22, i.e., either the small disks or the large disks correspond with the open area of the checkerboard of the ground plane, the respective absorption resonance will be deactivated for either the high frequency or the low frequency, respectively. In such embodiments, a micromechanical actuator may be position to move the ground plane checkerboard or the patterned nanostructure laterally relative to one another, and by virtue of the sliding mechanism, the metal film may be located under the large disks or the small disks, but not both. For example, when the metallic film areas of the ground plane are under the small disks, the higher frequency absorption will be activated, and because the open areas of the ground plane are under the large disks, the low frequency absorption will be deactivated. When the groundplane is displaced laterally so that the metal films are under the large disks, the low frequency absorption will be activated and the high frequency absorption deactivated. The entire switching between two widely separated bands requires a lateral motion on the order of only micrometers. The resulting optical reflectance in the two states has been simulated by computation presented in FIG. 24.

Embodiments of the invention also include methods for modifying the transmission wavelength of a patterned nanostructure by providing an upper medium overlying at least a portion of a patterned nanostructure component to create tunable or switchable metamaterial filters for the mid-IR wavelengths and moving the upper medium relative to the patterned nanostructure component. In some embodiments, movement of the upper medium may be carried out by vertically actuating in which the upper medium is moved away from or closer to the patterned nanostructure component. In other embodiments, movement of the upper medium may be carried out by laterally actuating the upper medium in which the separation between the patterned nanostructure component and the upper medium remains fixed and the upper medium is moved laterally relative to the patterned nanostructure component. As described above, in some embodiments, the upper medium may be a natural material, such as, a superconductor wafer, glass, or crystal and in other embodiments, the upper medium may be a second patterned nanostructure, which can be either the same or a different patterned nanostructure than the patterned nanostructure component. In still other embodiments, the upper medium may be structured or non-structured.

The embodiments provided above are based on five principles. First, certain regions in the patterned nanostructure plane can be provided by design where electric or magnetic fields are concentrated, and change of the index of the medium or changing the medium itself at these locations leverages the tuning effect. Second, while it has proven difficult or impossible for the n of the substrate or upper medium to be dynamically controlled by electrical means in the case of infrared components, it is nevertheless possible to effectively change the index in the most sensitive regions simply by mechanically actuating the placement of alternative materials in said sensitive regions. In other words, moving a high index material into a sensitive region which before was occupied by air, effectively creates a very large change in refractive index. Third, this can be effected either by vertical or lateral microactuation of a high index upper medium relative to the patterned nanostructure device layer. Fourth, due to the very small size of the unit cells relative to the wavelength, the amount of micromechanical actuation required to effect tuning or switching by movement of certain structures relative to others, is very small. For example, a filter designed for use at 10 micrometers can be broadly tuned by micromechanical actuation on the scale of less than 1 micrometer that is the size of the unit cell rather than a wavelength. This is a significant advantage over other types of optical device tuning which require movements of at least a wavelength for substantial tuning. Fifth, the micromechanical actuation of an upper medium to control its proximity relative to the patterned nanostructure device layer can, alternatively, use an upper medium which is itself a patterned nanostructure rather than a natural material. This greatly expands the range of designs and optical spectral characteristics which can be obtained.

Without wishing to be bound by theory, if the material immediately above or below or in proximity to the gaps of the split rings can be changed from a relatively low index to a relatively high index material (but still transparent at the wavelength of use), the resonant frequency of the SRRs may be significantly tuned due to the change in effective capacitance or inductance. The accessible region for the index to be changed is above the patterned nanostructure plane. The change to the index may be accomplished by physically moving pieces or layers of high index materials in or out of the key regions near the gaps, mechanically. Because of the small scale of the cells and the small extent of the fringing fields, the amount of mechanical movement required to obtain tuning or switching this way can be very small. The effective space-averaged index of the region immediately above the patterned nanostructure plane can be controlled by bringing a second wafer of some relatively high index material in proximity to the filter layer, and then varying the distance from the filter layer surface by a mechanical or micromechanical means, such as are well known in the art of MEMs for micro devices.

Electromagnetic theory shows that the resonant frequency of split ring resonators or similar metastructures can be highly sensitive to the refractive index (or equivalently, the permittivity and permeability) of the filter substrate and also the space within a fraction of a wavelength immediately above the patterned nanostructure layer. This sensitivity is particularly strong in the vicinity of the gap of split rings because of the large local electrical fields at the gap. It is further believed that by replacing the air above the gap in the split ring layer with a higher index material, the electromagnetic environment may be substantially altered, the effective capacitance of the gap region may be changed, and the device will be tuned in frequency. Alternatively, a medium with strong magnetic properties brought close to the ring, to replace or partially replace the air above the device plane with a higher permeability, may also alter the resonant frequency. Thus, by positioning the patterned nanostructure resonator layer and the semiconductor or patterned nanostructure other material layer such that the layers of the metamaterial filter can be physically moved relative to one another and providing a mechanism to allow the patterned nanostructure resonator layer and the semiconductor or patterned nanostructure other material layer to be moved, a tunable metamaterial filter can be produced. The transmission wavelength, or center wavelength, may be tuned by as much as 100% or even 400% of the center wavelength in this manner allowing for a tunable filter that can provide a narrow or wide band of transmission throughout a substantial IR spectral range. In some embodiments, the tuning method may modify transmission frequencies in the IR spectral range, and in certain embodiments, filter elements with such large dynamic tuning ranges can be achieved throughout the mid IR, for center wavelengths from about 2 μm to about 30 μm in wavelength (about 150 THz to about 10 THz frequency). In other embodiments, the tuning methods embodied herein may be used to modify the transmission frequency of any material and may be used to modify transmission or reflection or absorption in any spectral range.

While particular embodiments are directed to filters useful for filtering EM in the IR spectral range having wavelength of about 1 μm to about 100 μm, a frequency of about 300 THz to about 3 THz, and an energy of about 1.24 eV to about 12.4 meV and tuning filters in such spectral range, the principles for achieving such filtering and for tuning the transmission peak described herein can be applied to filters used for filtering EM radiation of any wavelength or frequency.

In various embodiments, the patterned nanostructure and upper medium of the devices of the invention may be positioned such that they can be physically moved relative to one another. For example, in some embodiments, the patterned nanostructure and the secondary material the devices may be positioned relative to one another such that at least two of the layers can be translated laterally relative to one another, and in other embodiments, the at least two layers of the metamaterial filter may be positioned such that they can be translated vertically relative to one another. Micromechanical actuation may be carried out by any means known in the art. For example, the secondary material may be moved either laterally or vertically relative to the patterned nanostructure by piezoelectric, electrostatic, or other methods known to the MEMS art. Even an actuation of less than 1 μm will be effective in widely tuning the metamaterial resonance. In some embodiments, vertical microactuation may be carried out by an electrical voltage which can be applied to a doped semiconductor upper medium that provides an electrostatic attraction between the upper medium and the patterned nanostructure component.

Natural material (non-patterned nanostructures) may be composed of any material provided that the secondary material is transparent at the wavelength at which the device is to be used. In certain embodiments, natural materials may have a different index of refraction than the patterned nanostructure component. Examples of secondary materials encompassed by embodiments of the invention include monolithic semiconductor or dielectric materials, structured or patterned semiconductor or dielectric materials, and the like or combinations material or two or more layers of materials, and in some embodiments, the secondary material may be a second patterned nanostructure. The index of refraction of such secondary materials may, generally, contrast the index of refraction of the metamaterial, and in certain, embodiments, the index of refraction for the secondary material may be higher than the index of refraction for the metamaterial.

Similarly, any of the metamaterial components described herein may be prepared from any patterned nanostructure known in the art. In general, these metamaterials may include an array of repeated unit cells in which each cell bears a pattern of metal traces on a dielectric or semiconductor substrate. In particular embodiments, the patterned nanostructure may be patterned or structured to exhibit resonant behavior that provides effective optical properties for high transmission over a desired bandwidth at IR frequencies. In embodiments in which the patterned nanostructure is patterned, the design of the pattern may include any conventional patterned nanostructure pattern including, but not limited to, split rings, Babinet split rings, dots, ovals, squares, triangles, rectangles, hexagons, octagons, bars, areas, crosses, multilayer designs that incorporate electric and magnetic resonances, and combinations thereof. In certain embodiments, the patterned nanostructure or secondary material may include an array of SRR resonators, and such embodiments are not limited by any particular arrangement or geometry. In some embodiments, the patterned nanostructure layer may be designed to include one or more conventional split rings such as those described above. In other embodiments, the patterned nanostructure layer may be designed, for example, to include one or more concentric rings where the ring may be a circular, triangular, rectangular, pentagonal, hexagonal, septagonal, octagonal, and the like ring structure. In other embodiments, the split rings may be arranged in parallel such that two or more split rings are side-by-side. Loops or rings may intersect to form complex geometries. In still other embodiments, a patterned nanostructure may be designed to include two or more split rings arranged in parallel and the individual split rings may share a side. In still other embodiments the patterns may be metal areas over the majority of the device plane with apertures over a minority of the device plane formed of holes, rings, etc.

Embodiments are not limited by the type of metal used as the metal component of such patterned nanostructures, and any metal known and useful in the art may be used in various embodiments of the invention. In certain embodiments, the metal may exhibit high conductivity and high reflectance at mid-IR wavelengths. In some embodiments, the metal component may be, for example, gold (Au), silver (Ag), copper (Cu), platinum (Pt), aluminum (Al), tungsten (W), and the like. In particular embodiments, the metal component may be gold (Au). The metal component may be provided at any suitable thickness sufficient to create the patterned nanostructure pattern. For example, in some embodiments, the metal component may be provided as a thin film having thickness of less than about 1 μm, less than about 100 nm, or about 50 nm.

The substrate material of the patterned nanostructure component or an upper medium composed of a patterned nanostructure of various embodiments may be any substrate material known and useful in the art. For example, in some embodiments, the substrate material may be any material including, but not limited to diamond, gallium arsenide (GaAs), zinc sulfide (ZnS), Ge, SiGe, GaInP AlGaAs, GaInAs AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H-SiC, a-Sn, BN, BP, BAs, MN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb. In particular embodiments, the substrate may be p-doped diamond, gallium arsenide (GaAs), or zinc sulfide (ZnS).

The thickness of the substrate component may vary among embodiments and may be of any thickness known in the art. In certain embodiments, the substrate component may be of such thickness that it is transparent to radiation in the spectral region of the EM radiation being filtered. For example, in some embodiments, the substrate component may have a thickness of about 1 mm to about 100 nm. In other embodiments, the substrate component may have a thickness of about 10 μm to about 100 nm, and in still other embodiments, the substrate component may have a thickness of about 1000 nm to about 500 nm. In embodiments in which the EM being filtered is in the IR spectral range having a wavelength of about 1 μm to about 100 μm, a frequency of about 300 THz to about 3 THz, and an energy of about 1.24 eV to about 12.4 meV, the thickness of the substrate layer may be about 100 μm to about 500 μm and, in particular embodiments, the substrate layer may have a thickness of about 250 μm. In other embodiments that feature a multiple layered substrate, the dynamic dielectric material may about 50 nm to about 1 μm and the base substrate may have a thickness of about 100 μm to about 500 μm.

In further embodiments, the patterned nanostructure component of the optical element may include a base or support substrate layer. In such embodiments, the material used to provide the base or support layer may be any material having static optical properties with suitably high transmissive qualities over a broad range of IR spectrum. Non-limiting examples of suitable supporting or base materials include silicon, quartz, ceramic materials and combinations thereof and the like.

In some embodiments, the upper medium may include a semiconductor material prepared from materials including, without limitation, p-doped diamond, Si, gallium arsenide (GaAs), zinc sulfide (ZnS), Ge, SiGe, GaInP AlGaAs, GaInAs AlInGaP, GaAsN, GaN, GaInN, InN, GaInAlN, GaAlSb, GaInAlSb, CdTe, MgSe, MgS, 6HSiC, ZnTe, CgSe, GaAsSb, GaSb, InAsN, 4H—SiC, a-Sn, BN, BP, BAs, MN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, and AlSb or the like. In some embodiments, the upper medium may be composed of the same material as the metamaterial substrate, and in other embodiments, the upper medium may be composed of a material having a higher refractive index than the patterned nanostructure component.

In certain embodiments, the upper medium may be patterned. For example, in some embodiments, as illustrated in FIG. 8 and FIG. 9, the pattern may provide for projections that are capable of interacting with the patterned nanostructure layer. In other embodiments, pattern of the upper medium may provide for electronic interactions that modify the transmission wavelength of the patterned nanostructure layer. In some embodiment, a high index upper medium may be etched into a ‘waffle’ pattern with mesas, pillars, or fingers on the same spatial period as the underlying filter as illustrated in FIG. 8 and FIG. 9. The mesa-etched wafer may be placed in contact with the device surface and lateral microactuation may be used to slide or translate the patterned high index layer laterally relative to the patterned nanostructure component so that the high index regions may be positioned over the gap regions or moved away from the gaps, as desired as illustrated in FIG. 9. Depending on the details of design, a very small lateral translation of the patterned nanostructure component relative to the upper medium (a small fraction of a wavelength) may substantially modify the filter response allowing for dynamic tuning.

In some embodiments, the metamaterial filter may be configured to provide continuous tuning. In such embodiments, the patterned nanostructure component and the upper medium may be moved smoothly relative to one another to provide a smooth transition between narrowband transmission wavelengths. Thus, a metamaterial filter may provide, for example, a narrowband transition at a center wavelength of about 3 μm to narrowband transmission at center wavelength of about 5 μm, traversing all the wavelengths in between. In other embodiments, the metamaterial filter may have two discrete states instead of being tuned continuously tuned. In such embodiments, the patterned nanostructure resonator layer and the semiconductor or patterned nanostructure other material layer may be arranged to provide a first pattern that may be dynamically reorganized to provide second, different pattern that provides a different spectral response from the first pattern of transmission/reflection/absorption. For example, in some embodiments, passband filters may be configured to transmit the entire 3-5 μm sub-band when in a first state and may be reorganized into a second state which transmits the entire 8-12 μm sub-band without traversing the wavelengths in between. In still other embodiments, optical devices may be configured to switch from being highly transmissive to highly reflective at a given wavelength band by moving the secondary material relative to the metamaterial.

Embodiments are also directed to a method of using such metamaterials filters including the steps of displacing a upper medium relative to a patterned nanostructure component, and by such displacement, tuning or switching of the transmission wavelength of the metamaterial. The displacement may be either lateral or vertical and may generally be carried out by micromechanical actuation. Without wishing to be bound by theory, the method of using the metamaterial devices of embodiments described herein takes advantage of the resonant frequency or other spectral behavior of a metamaterial which is highly sensitive to the material properties such as permittivity and permeability, in the region a fractional wavelength above the device layer, especially at gaps of split rings; and the cell size of the patterned nanostructures, which is typically a small fraction of the resonant wavelength, may require a small amount of physical movement required to effectively change the optical environment. As shown in FIG. 6, adjusting the distance between the secondary layer and the patterned nanostructure pattern such as, for example, split rings, can effectively tune the device by altering the space-averaged index in the upper half space.

Certain embodiments are directed to methods for preparing the metamaterial filters described herein. Fabrication of such materials may be carried out by any method known in the art. For example, in some embodiments, a patterned nanostructure may be prepared by depositing a metal component on a surface of a substrate in a pattern of exposed substrate and coated metal portions using photolithography, pattern stamping, photomasking, or electron beam lithography to create an array of individual patterned nanostructures. In other embodiments, the metal component may be depositing on a surface of a substrate as a continuous or substantially continuous sheet, and a pattern of exposed substrate and coated metal may be created using various etching techniques. In still other embodiments, the method may include the step of depositing a substrate material onto a base or support substrate and depositing a metal component onto the substrate material. The substrate materials, base or support substrate materials, and metal components of various such embodiments include any of the materials described above.

### EXAMPLES

Although the present invention has been described in considerable detail with reference to certain preferred embodiments thereof, other versions are possible. Therefore the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Example 1

A diamond-substrate metamaterial can be prepared by providing a secondary material of the same diamond substrate positioned to overlay the patterned nanostructure and separated by a variable standoff distance, as in the scheme of the First Embodiment. The curves of FIG. 4 show the expected standoff separations of 300 nm, 150 nm, 50 nm, and 0 nm respectively (0 means contact). These data show that a filter designed as embodied herein can be effectively tuned from a transmission maximum at 7.2 μm to 9.5 μm. Although the second layer in this example is the same material as the substrate, it is believed that the tuning will be even greater than shown if the second layer has a relatively higher index than the substrate.

### Example 2

A two layer filter will be designed to obtain a desired characteristic: a high transmission in the 3-5 μm range and low transmission in the 8-12 μm range. Next, one layer will be shifted in relative to the second by ½ period and the effect on the spectrum should be observed. The design was then adjusted to obtain a desired second characteristic, i.e. to reverse the ranges. The design procedure is iterated until both states are optimized.

### Example 3

FIG. 10C shows the layer pattern of each of the two layers of an identical two layer metamaterial filter designed so that lateral displacement will cause the filter to substantially change the overall character of its transmission spectrum. In this embodiment, the second layer is identical to the first layer. This example is intended to switch from transmitting mostly in the 3-5 μm band to translating mostly in the 8-12 μm band.

FIGS. 11A and 11B illustrates the two transmission states which result, which are effected simply by displacing the two layers of laterally relative to one another by one half the cell period. As shown in this computational simulation, the net transmittance of the filter device is substantially shifted from the 3-5 μm window to the 8-12 μm window, simply by shifting one layer relative to the second by a very small distance on the order of 1 μm.

1. A switchable optical element having an optical response to an incident radiation, the optical element comprising:
a ground plane;
a patterned nanostructure of metallic features disposed on a dielectric spacer layer electromagnetically coupled to the ground plane;
a third component configured to be electromagnetically coupled to the patterned nanostructure; and
one or more micromechanical actuator operably connecting the patterned nanostructure and the third component, the one or more micromechanical actuator being capable of providing vertical actuation of the third component relative to the patterned nanostructure,
wherein the optical element optically responds in a first manner to the incident radiation when the third component is at a first vertical displacement from the patterned nanostructure, and optically responds in a second manner to the incident radiation when the third component is at a second vertical displacement from the patterned nanostructure.

2. The optical element of claim 1, wherein the incident radiation has at least one wavelength of about 1.5 μm to about 15 μm.

3. The optical element of claim 1, wherein the ground plane is a conductive material.

4. The optical element of claim 1, wherein the ground plane is selected from the group consisting of gold, silver, copper, platinum, tungsten, and aluminum.

5. The optical element of claim 1, wherein each of the metallic features has a geometric shape and comprises a first metal.

6. The optical element of claim 5, wherein the geometric shape comprises one or more of the following: circles, ovals, squares, rectangles, triangles, regular polygons, cruciform or irregular shapes.

7. The optical element of claim 1, wherein the pattern nanostructure comprises a two-dimensional array of metallic features.

8. The optical element of claim 7, wherein the two-dimensional array of metallic features comprises one or more of:
a regular array of metallic features, each of the features having a same geometry;
a regular array of metallic features, each feature having a geometry that differs from at least one other feature;
an irregular array of metallic features, each of the features having a same geometry; or
an irregular array of metallic features, each feature having a geometry that differs from at least one other feature.

9. The optical element of claim 1, wherein the dielectric spacer layer is selected from the group consisting Si₃N₄ and Al₂O₃.

10. The optical element of claim 5, wherein the first metal is selected from the group consisting of gold, silver, copper, platinum, tungsten, and aluminum.

11. The optical element of claim 1, wherein the third component comprise a plurality of metallic tabs patterned on a film to produce a two-dimensional array of tabs.

12. The optical element of claim 11, wherein the metallic tabs comprise a second metal.

13. The optical element of claim 11, wherein the second metal is selected from the group consisting of gold, silver, copper, platinum, tungsten, and aluminum.

14. The optical element of claim 11, wherein each of the metallic features comprise a first metal, each of the metallic tabs comprise the first metal.

15. The optical element of claim 11, wherein each of the metallic features comprise a first metal, each of the metallic tabs comprise a second metal, and the first metal differs from the second metal.

16. The optical element of claim 11, wherein the film is selected from the group consisting Si₃N₄ and Al₂O₃.

17. The optical element of claim 11, wherein each metallic tab is configured to have a first portion capable of contacting at least a portion of a first metallic feature of the patterned nanostructure and a second portion capable of contacting at least a portion of a second metallic feature of the patterned nanostructure, wherein the second metallic feature is horizontally or vertically adjacent to the first metallic feature in a two-dimensional array of metallic features.

18. The optical element of claim 17, wherein the first vertical displacement is a distance between the patterned nanostructure and the third component wherein the first portion of each metallic tab does not contact the at least portion of the first metallic feature and the second portion of each metallic tab does not contact the at least portion of the second metallic feature.

19. The optical element of claim 17, wherein the second vertical displacement is a distance between the patterned nanostructure and the third component wherein the first portion of each metallic tab contacts the at least portion of the first metallic feature and the second portion of each metallic tab contacts the at least portion of the second metallic feature.

20. The optical element of claim 17, wherein the first manner of optical response comprises an absorbance by the optical element of at least at one wavelength of the incident radiation.

21. The optical element of claim 20, wherein the second manner of optical response comprises a reflectance by the optical element of the at least one wavelength of the incident radiation.

22. The optical element of claim 1, wherein the one or more micromechanical actuators provides vertical actuation by piezoelectric means, electrostatic means, or combinations thereof.

23. The optical element of claim 1, wherein each micromechanical actuator is configured to vertically change a position of the first patterned nanostructure layer relative to the third component by about 1 nm to about 1000 nm.

24. The optical element of claim 1, wherein the optical response to the incident radiation is one or more of the following: an absorbance and a reflectance.

25. An optical element having an optical response to an incident radiation, the optical element comprising:
a ground plane; and
a patterned nanostructure of metallic features disposed on a dielectric spacer layer electromagnetically coupled to the ground plane,
wherein the metallic features, each feature having a geometric shape, are patterned to produce a two-dimensional array of metallic features, and
wherein the two-dimensional array of metallic features has an x-dimension spatial period, a y-dimension spatial period, and the x-dimension spatial period differs from the y-dimension spatial period.

26. The optical element of claim 25, wherein the optical response to the incident radiation is one or more of the following: absorbance and reflectance.

27. The optical element of claim 25, wherein the optical response to the incident radiation is effectively independent of a value of an angle of incidence of the incident radiation with respect to a surface of the patterned nanostructure of the optical element.

28. The optical element of claim 25, wherein the optical response to the incident radiation is effectively independent of a polarization value of the incident radiation with respect to a surface of the patterned nanostructure of the optical element.

29. The optical element of claim 25, wherein the geometric shape comprises one or more of the following: circles, ovals, squares, rectangles, triangles, regular polygons, cruciform shapes and irregular shapes.

30. The optical element of claim 25, wherein the geometric shape has an x-dimension diameter, a y-dimension diameter, and the x-dimension diameter differs from the y-dimension diameter.

31. The optical element of claim 25, wherein the geometric shape has an x-dimension diameter and the x-dimension spatial period is from about 0.1% of the x-dimension diameter to about 100% of the x-dimension diameter.

32. The optical element of claim 25, wherein the geometric shape has a y-dimension diameter and the y-dimension spatial period is from about 0.1% of the y-dimension diameter to about 100% of the y-dimension diameter.

33. An optical element having an optical response to an incident radiation, the optical element comprising:
a ground plane; and
a patterned nanostructure of metallic features disposed on a dielectric spacer layer electromagnetically coupled to the ground plane,
wherein the metallic features, each feature having a geometric shape, are patterned to produce a two-dimensional array of metallic features, and
wherein the geometric shape has an x-dimension diameter, a y-dimension diameter, and the x-dimension diameter differs from the y-dimension diameter.

34. The optical element of claim 33, wherein the optical response to the incident radiation is one or more of the following: absorbance and reflectance.

35. The optical element of claim 33, wherein the optical response to the incident radiation is effectively independent of a value of an angle of incidence of the incident radiation with respect to a surface of the patterned nanostructure of the optical element.

36. The optical element of claim 33, wherein the optical response to the incident radiation is effectively independent of a polarization value of the incident radiation with respect to a surface of the patterned nanostructure of the optical element.

37. The optical element of claim 33, wherein the geometric shape comprises one or more of the following: ovals, rectangles, triangles, cruciform shapes having unequal arm lengths, and irregular shapes.

38. The optical element of claim 33, wherein the two-dimensional array of features has an x-dimension spatial period, a y-dimension spatial period, and the x-dimension spatial period differs from the y-dimension spatial period.

39. The optical element of claim 33, wherein the two-dimensional array of metallic features has an x-dimension spatial period and the x-dimension spatial period is from about 0.1% of the x-dimension diameter to about 100% of the x-dimension diameter.

40. The optical element of claim 33, wherein the two-dimensional array of metallic features has a y-dimensional spatial period and the y-dimension spatial period is from about 0.1% of the y-dimension diameter to about 100% of the y-dimension diameter.

41. A method for switching an optical response of an optical element to an incident radiation, the method comprising:
providing an optical element comprising a ground plane, a patterned nanostructure of metallic features disposed on a dielectric spacer layer electromagnetically coupled to the ground plane, and a third component configured to be electromagnetically coupled to the patterned nanostructure; and
moving the patterned nanostructure a vertical distance relative to the third component,
wherein the optical element optically responds in a first manner to the incident radiation when the third component is at a first vertical displacement from the patterned nanostructure, and optically responds in a second manner to the incident radiation when the third component is at a second vertical displacement from the patterned nanostructure.

42. The method of claim 41, wherein switching comprises modifying a reflective spectrum or an absorption spectrum in an infrared spectral region.

43. The optical element of claim 41, wherein the first manner of optical response comprises an absorbance by the optical element of at least at one wavelength of the incident radiation.

44. The optical element of claim 43, wherein the second manner of optical response comprises a reflectance by the optical element of the at least one wavelength of the incident radiation.
